(19) United States
(12) Patent Application Publication
(10) Pub. No.: US 2025/0350749 A1
(43) Pub. Date: Nov. 13, 2025

(54) IMAGE DECODING METHOD AND DEVICE, AND IMAGE ENCODING METHOD AND DEVICE

(71) Applicant: Samsung Electronics Co., Ltd., Suwon-si (KR)

(72) Inventors: Quockhanh DINH, Suwon-si (KR); Minwoo Park, Suwon-si (KR); Kwangpyo Choi, Suwon-si (KR)

(73) Assignee: Samsung Electronics Co., Ltd., Suwon-si (KR)

(21) Appl. No.: 19/272,728

(22) Filed: Jul. 17, 2025

Related U.S. Application Data
(63) Continuation of application No. PCT/KR2024/000482, filed on Jan. 10, 2024.

(30) Foreign Application Priority Data
Jan. 18, 2023 (KR) 10-2023-0007641
Apr. 20, 2023 (KR) 10-2023-0052206

(51) Int. Cl. H04N 19/196; H04N 19/124; H04N 19/137; H04N 19/172; H04N 19/573

(52) U.S. Cl. CPC H04N 19/196; H04N 19/124; H04N 19/137; H04N 19/172; H04N 19/573

(57) ABSTRACT

An image decoding method includes obtaining, from a bitstream, feature data obtained via neural network-based encoding of a current image, and linear correction parameters for the current image, obtaining image data for the current image by inputting the feature data to a decoding neural network, and reconstructing the current image by applying the linear correction parameters to the image data.

### CROSS-REFERENCE TO RELATED APPLICATIONS

This application is a continuation application of International Application No. PCT/KR2024/000482, filed on Jan. 10, 2024, which is based on and claims priority to Korean Provisional Application No. 10-2023-0007641, filed on Jan. 18, 2023, in the Korean Intellectual Property Office, and Korean Patent Application No. 10-2023-0052206, filed on Apr. 20, 2023, in the Korean Intellectual Property Office, the disclosures of which are incorporated by reference herein in their entireties.

### BACKGROUND

### 1. Field

The present disclosure relates to encoding and decoding of an image, and more particularly, the to a technique for encoding and decoding an image by using artificial intelligence (AI), for example, a neural network.

### 2. Description of Related Art

Codecs such as H.264 Advanced Video Coding (AVC) and High Efficiency Video Coding (HEVC) may divide an image into blocks, predict each block, transform a residual block, which is a difference between the original block and the predicted block, to obtain a transformed block, quantize and entropy-encode the transformed block, and transmit the result as a bitstream.

From the transmitted bitstream, the transformed block may be obtained via entropy decoding and inverse quantization, then the transformed block may be inverse transformed to obtain the residual block, and the block may be reconstructed by using the residual block and a predicted block obtained via prediction.

Recently, techniques have been proposed for encoding/decoding an image by using artificial intelligent (AI), and there is a need for a method of effectively encoding/decode an image by using AI, for example, a neural network.

### SUMMARY

According to an aspect of the disclosure, an image decoding method may include: obtaining, from a bitstream, feature data obtained via neural network-based encoding of a current image, and linear correction parameters for the current image; obtaining image data for the current image by inputting the feature data to a decoding neural network; and reconstructing the current image by applying the linear correction parameters to the image data.

According to an aspect of the disclosure, the image decoding device may include: a memory storing one or more instructions; and at least one processor configured to operate according to the one or more instructions. The at least one processor may obtain, from a bitstream, feature data obtained via neural network-based encoding of a current image, and linear correction parameters for the current image. The at least one processor may obtain image data for the current image by inputting the feature data to a decoding neural network. The at least one processor may reconstruct the current image by applying the linear correction parameters to the image data.

According to an aspect of the disclosure, an image decoding method may include: obtaining, from a bitstream, feature data obtained via neural network-based encoding of a current image, and linear correction parameters for the current image; obtaining previous layer parameters and final layer parameters for a decoding neural network; correcting the final layer parameters by applying the linear correction parameters to the final layer parameters; and reconstructing the current image by using the previous layer parameters, the corrected final layer parameters, and the feature data.

According to an aspect of the disclosure, the image decoding device may include: a memory storing one or more instructions; and at least one processor configured to operate according to the one or more instructions. The at least one processor may obtain, from a bitstream, feature data obtained via neural network-based encoding of a current image, and linear correction parameters for the current image. The at least one processor may obtain previous layer parameters and final layer parameters for a decoding neural network. The at least one processor may correct the final layer parameters by applying the linear correction parameters to the final layer parameters. The at least one processor may reconstruct the current image by using the previous layer parameters, the corrected final layer parameters, and the feature data.

According to an aspect of the disclosure, an image encoding method may include: obtaining first feature data for a current original image by inputting the current original image to an encoding neural network; obtaining second feature data via quantization and inverse quantization of the first feature data; obtaining image data for the current original image by inputting the second feature data to a decoding neural network; generating linear correction parameters for the current original image via error modeling for minimizing errors by using the current original image and the image data; and generating a bitstream including the first feature data and the linear correction parameters.

According to an aspect of the disclosure, the image encoding device may include: a memory storing one or more instructions; and at least one processor configured to operate according to the one or more instructions. The at least one processor may obtain first feature data for a current original image by inputting the current original image to an encoding neural network. The at least one processor may obtain second feature data via quantization and inverse quantization of the first feature data. The at least one processor may obtain image data for the current original image by inputting the second feature data to a decoding neural network. The at least one processor may generate linear correction parameters for the current original image via error modeling for minimizing errors by using the current original image and the image data. The at least one processor may generate a bitstream including the first feature data and the linear correction parameters.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating encoding and decoding processes for a current image based on intra prediction, according to an embodiment of the present disclosure;

FIG. 2 is a diagram illustrating encoding and decoding processes for a current image based on inter prediction, according to an embodiment of the present disclosure;

FIG. 3 illustrates an example of a rate-distortion cost for frames of each sequence;

FIG. 4 is a diagram for schematically describing a process in which linear correction parameters are derived at an encoder side and transmitted to a decoder side to perform linear correction, according to an embodiment of the present disclosure;

FIG. 5 is a diagram for schematically describing a process in which linear correction parameters are derived at an encoder side and transmitted to a decoder side to perform linear correction, according to an embodiment of the present disclosure;

FIG. 6 is a diagram illustrating a process in which linear correction is performed in intra prediction, according to an embodiment of the present disclosure;

FIG. 7 is a diagram illustrating a process in which linear correction is performed in intra prediction, according to an embodiment of the present disclosure;

FIG. 8 is a diagram illustrating a process in which linear correction is performed in inter prediction, according to an embodiment of the present disclosure;

FIG. 9 is a diagram illustrating a process in which linear correction is performed in inter prediction, according to an embodiment of the present disclosure;

FIG. 10 is a diagram illustrating a process in which linear correction is performed in inter prediction, according to an embodiment of the present disclosure;

FIG. 11 is a diagram illustrating a process in which linear correction is performed in inter prediction, according to an embodiment of the present disclosure;

FIG. 12 illustrates an example of a rate-distortion cost for frames of each sequence, and a rate-distortion cost in a case in which linear correction is applied;

FIG. 13 is a diagram for describing an image decoding method according to an embodiment of the present disclosure;

FIG. 14 is a block diagram illustrating a configuration of an image decoding device according to an embodiment of the present disclosure;

FIG. 15 is a diagram for describing an image decoding method according to an embodiment of the present disclosure;

FIG. 16 is a block diagram illustrating a configuration of an image decoding device according to an embodiment of the present disclosure;

FIG. 17 is a diagram for describing an image encoding method according to an embodiment of the present disclosure;

FIG. 18 is a block diagram illustrating a configuration of an image encoding device according to an embodiment of the present disclosure; and

FIG. 19 is a diagram for describing a method of training neural networks, according to an embodiment of the present disclosure.

### DETAILED DESCRIPTION

As used herein, the expression “at least one of a, b, or c” may indicate only a, only b, only c, both a and b, both a and c, both b and c, or all of a, b, and c.

As the present disclosure allows for various changes and numerous embodiments, particular embodiments will be illustrated in the drawings and described in detail. However, this is not intended to limit the present disclosure to modes of practice, and it should be understood that all changes, equivalents, and substitutes that do not depart from the spirit and technical scope of the present disclosure are encompassed in the present disclosure.

In a description of an embodiment, a detailed description of relevant well-known techniques will be omitted when it unnecessarily obscures the gist of the present disclosure. In addition, ordinal numerals (e.g., ‘first’ or ‘second’) used in the description of the specification are identifier codes for distinguishing one component from another.

In addition, in the present disclosure, it should be understood that when components are “connected” or “coupled” to each other, the elements may be directly connected or coupled to each other, but may alternatively be connected or coupled to each other with an element therebetween, unless specified otherwise.

Also, in the present disclosure, a component expressed as, for example, ‘ . . . er (or)’, ‘ . . . unit’, ‘ . . . module’, or the like, may denote a unit in which two or more components are combined into one component or one component is divided into two or more components according to its function. In addition, each component to be described below may additionally perform, in addition to its primary function, some or all of functions of other components take charge of, and some functions among primary functions of the respective components may be exclusively performed by other components.

In addition, in the present disclosure, an ‘image’ or ‘picture’ may refer to a still image (or a frame), a moving image including a plurality of consecutive still images, or a video.

In the present disclosure, a ‘neural network’ refers to a representative example of an artificial neural network model that mimics brain nerves, and is not limited to an artificial neural network model using a particular algorithm. A neural network may also be referred to as a deep neural network.

In the present disclosure, a ‘parameter’ refers to a value used in a computation process of each layer constituting a neural network, and for example, may be used when applying an input value to a certain arithmetic expression. A parameter is a value set as a result of training, and may be refined by using separate training data when necessary.

In the present disclosure, ‘feature data’ may refer to data obtained as a neural network or a neural network-based encoder processes input data. Feature data may be one-dimensional or two-dimensional data including multiple samples. Feature data may also be referred to as a latent representation. Feature data may represent features inherent in data output by a neural network-based decoder.

In the present disclosure, a ‘current image’ refers to an image currently being processed, and a ‘previous image’ refers to an image processed prior to the current image. The ‘current image’ or ‘previous image’ may also refer to a block obtained by partitioning the current image or previous image.

In the present disclosure, a ‘sample’ is data assigned to a sampling position within one-dimensional or two-dimensional data such as an image, a block, or feature data, and refers to data to be processed. For example, a sample may include pixels within a two-dimensional image. Two-dimensional data may also be referred to as a ‘map’.

An artificial intelligence (AI)-based end-to-end encoding/decoding system may be understood as a system that uses a neural network in image encoding and decoding processes.

Similar to codecs such as High Efficiency Video Coding (HEVC) or Versatile Video Coding (VVC), an AI-based end-to-end encoding/decoding system may use intra prediction or inter prediction for image encoding and decoding.

Intra prediction is a method of compressing an image by removing spatial redundancy within the image, whereas inter prediction is a method of compressing images by removing temporal redundancy between the images.

In an embodiment, intra prediction may be applied to the first frame among multiple frames, a frame designated as a random access point, and a frame where a scene change occurs.

In an embodiment, inter prediction may be applied to frames subsequent to a frame, among multiple frames, to which intra prediction is applied.

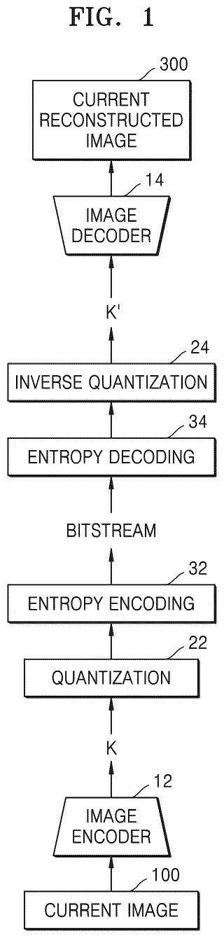

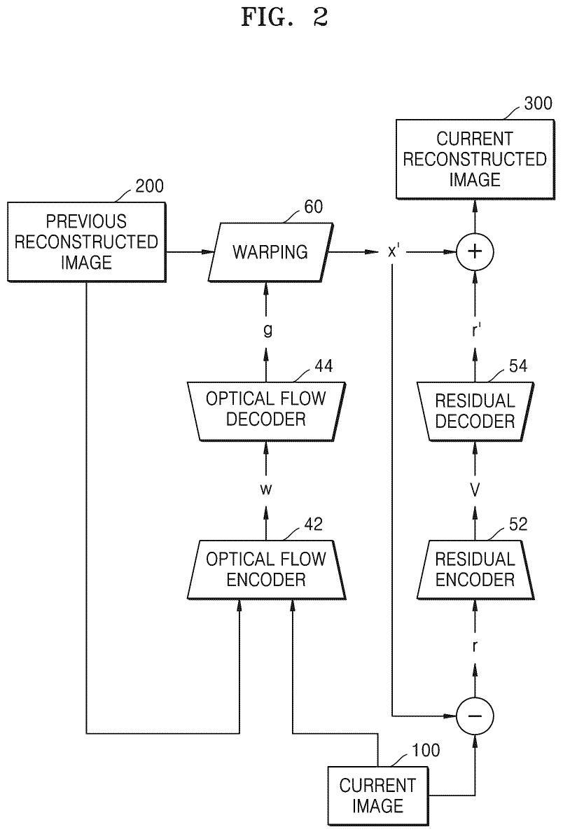

Intra prediction and inter prediction both performed by an AI-based end-to-end encoding/decoding system according to an embodiment will be described with reference to FIGS. 1 and 2.

FIG. 1 is a diagram illustrating encoding and decoding processes for a current image 100 based on intra prediction, according to an embodiment of the present disclosure.

For intra prediction, an image encoder 12 and an image decoder 14 may be used. The image encoder 12 and the image decoder 14 may be implemented as neural networks.

The image encoder 12 may process the current image 100 based on parameters that are set via training, to output feature data k for the current image 100.

A bitstream may be generated by applying quantization 22 and entropy encoding 32 to the feature data k for the current image 100, and then delivered from an image encoding device to an image decoding device.

Reconstructed feature data k′ may be obtained by applying entropy decoding 34 and inverse quantization 24 to the bitstream, and then input to the image decoder 14.

The image decoder 14 may process the feature data k′ based on parameters that are set via training, to output a current reconstructed image 300.

Because intra prediction considers spatial features within the current image 100, only the current image 100 may be input to the image encoder 12, unlike inter prediction illustrated in FIG. 2.

FIG. 2 is a diagram illustrating encoding and decoding processes for the current image 100 based on inter prediction, according to an embodiment of the present disclosure.

For inter prediction, an optical flow encoder 42, an optical flow decoder 44, a residual encoder 52, and a residual decoder 54 may be used.

The optical flow encoder 42, the optical flow decoder 44, the residual encoder 52, and the residual decoder 54 may be implemented as neural networks.

The optical flow encoder 42 and the optical flow decoder 44 may be understood as neural networks configured to extract an optical flow g from the current image 100 and a previous reconstructed image 200.

The residual encoder 52 and the residual decoder 54 may be understood as neural networks configured for encoding and decoding of a residual image r.

As described above, inter prediction is a process of encoding and decoding the current image 100 by using temporal redundancy between the current image 100 and the previous reconstructed image 200. The previous reconstructed image 200 may be an image obtained via decoding for a previous image that has been processed before processing the current image 100.

A positional difference (or a motion vector) between blocks or samples within the current image 100 and reference blocks or reference samples within the previous reconstructed image 200 may be used for encoding and decoding of the current image 100. Such a positional difference may be referred to as an optical flow. An optical flow may also be defined as a set of motion vectors corresponding to samples or blocks within an image.

The optical flow g may represent how the positions of samples within the previous reconstructed image 200 have changed in the current image 100, or where samples that are identical or similar to samples within the current image 100 are located in the previous reconstructed image 200.

For example, when a sample that is identical or most similar to a sample located at (1, 1) in the current image 100 is located at (2, 1) in the previous reconstructed image 200, the optical flow g or motion vector for the corresponding sample may be derived as (1(=2−1), 0(=1−1)).

For encoding of the current image 100, the previous reconstructed image 200 and the current image 100 may be input to the optical flow encoder 42.

The optical flow encoder 42 may process the current image 100 and the previous reconstructed image 200 based on parameters that are set via training, to output feature data w for the optical flow g.

As described above with reference to FIG. 1, a bitstream may be generated by applying the quantization 22 and the entropy encoding 32 to the feature data w for the optical flow g, and the feature data w for the optical flow g may be reconstructed by applying the entropy decoding 34 and the inverse quantization 24 to the bitstream.

The feature data w for the optical flow g may be input to the optical flow decoder 44. The optical flow decoder 44 may process the input feature data w based on parameters that are set via training, to output the optical flow g.

The previous reconstructed image 200 may be warped via warping 60 based on the optical flow g, and as a result of the warping 60, a current predicted image x′ may be obtained. The warping 60 refers to a type of geometric transformation that shifts the positions of samples within an image.

The current predicted image x′, which is similar to the current image 100, may be obtained by applying the warping 60 to the previous reconstructed image 200 according to the optical flow g, which represents a relative positional relationship between samples within the previous reconstructed image 200 and samples within the current image 100.

For example, when a sample located at (1, 1) in the previous reconstructed image 200 is most similar to a sample located at (2, 1) in the current image 100, the position of the sample at (1, 1) in the previous reconstructed image 200 may be changed to (2, 1) via the warping 60.

Because the current predicted image x′ generated from the previous reconstructed image 200 is not identical to the current image 100 itself, the residual image r between the current predicted image x′ and the current image 100 may be obtained.

For example, the residual image r may be obtained by subtracting sample values within the current predicted image x′ from sample values within the current image 100.

The residual image r may be input to the residual encoder 52. The residual encoder 52 may process the residual image r based on parameters that are set via training, to output feature data v for the residual image r.

As described above with reference to FIG. 1, a bitstream may be generated by applying the quantization 22 and the entropy encoding 32 to the feature data v for the residual image r, and the feature data v for the residual image r may be reconstructed by applying the entropy decoding 34 and the inverse quantization 24 to the bitstream.

The feature data v for the residual image r may be input to the residual decoder 54. The residual decoder 54 may process the input feature data v based on parameters that are set via training, to output a reconstructed residual image r′.

In addition, according to an embodiment, the feature data w for the optical flow g may be additionally input to the residual decoder 54, in addition to the feature data v for the residual image r. The residual decoder 54 may process the input feature data v and the feature data w for the optical flow g based on parameters that are set via training, to output the reconstructed residual image r′. Because both the optical flow g and the residual image r are used for inter prediction, the reconstructed residual image r′ may be obtained by using both the feature data v for the residual image r and the feature data w for the optical flow g.

The current reconstructed image 300 may be obtained by combining the current predicted image x′ with the reconstructed residual image r′.

In addition, as described above, the quantization 22 and the inverse quantization 24 may be applied to the feature data k for the current image 100, the feature data w for the optical flow g, and the feature data v for the residual image r.

Quantization and inverse quantization may cause coding errors. In detail, the quantization process is performed by rounding an input value, that is, by adding 0.5 to the input value and then inputting the result value to a floor function that outputs the nearest integer to the result value, as shown in Equation 1 below.

$$Q ( x ) = floor ( x + 0.5 ) \qquad [ Equation 1 ]$$

Quantization errors in feature data, which is also referred to as a latent representation, may cause errors in feature data for a decoded optical flow, the decoded optical flow, feature data for decoded residual pixels, or the decoded residual pixels.

In addition, errors in the current frame may propagate to subsequent frames. Due to distribution shifts in an input to encoder and decoder networks, error degradation may lead to more severe errors.

During training of a neural network, the quantization process is imitated by adding random uniform noise as shown in Equation 2, and during testing of the neural network, the quantization process is performed by rounding an input value as shown in Equation 1.

$$Q ( x ) = x + n where n ∼ U [ - 0.5 ∼ 0.5 ] \qquad [ Equation 2 ]$$

A dataset used for training may not sufficiently cover the spatial and temporal transformations in video content, and the sequence lengths may be typically limited to 4 frames, 10 frames, or 12 frames, or may not be limited in units of minutes or hours. Overfitting caused by differences between a training dataset and a test may lead to coding errors.

Coding errors may cause coding efficiency to decrease over time. Error propagation may be severe for some sequences. The rate-distortion cost for a sequence may increase over time. That is, performance degradation may occur in some sequences, and in particular, frames that are distant from an intra frame may exhibit low coding efficiency, and the rate-distortion cost may significantly increase over time.

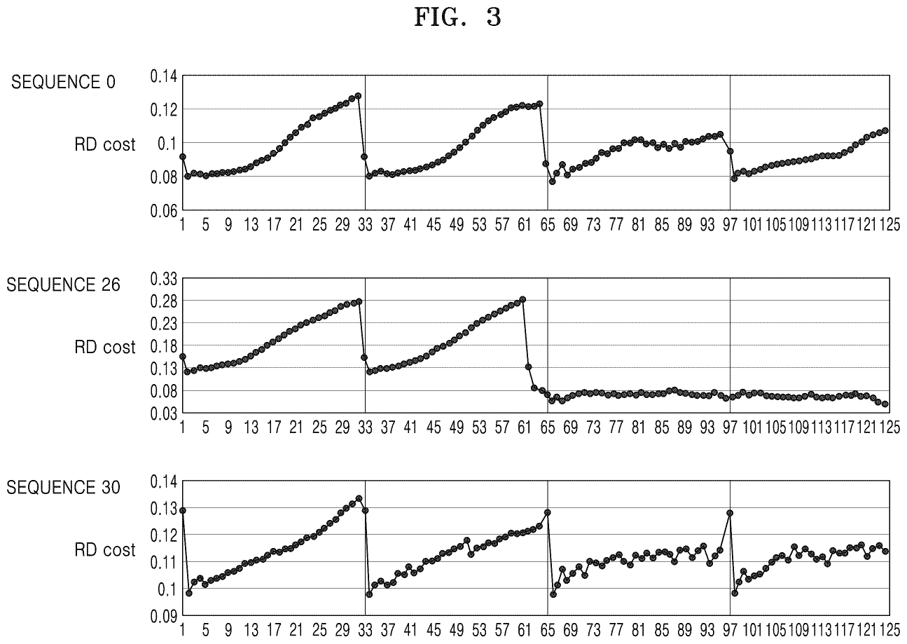

FIG. 3 illustrates an example of a rate-distortion cost for frames of each sequence.

Referring to FIG. 3, in sequences 0 and 30, the rate-distortion cost increases with increasing distance from the intra frame during each intra period, whereas in sequence 26, the rate-distortion cost increases with increasing distance from the intra frame during the first two intra periods but remains at a low level during the latter two intra periods. That is, it is confirmed that for frames distant from the intra frame, for example, frame 32, the farthest from frame 1 in sequence 0, the rate-distortion cost is high, indicating low coding efficiency.

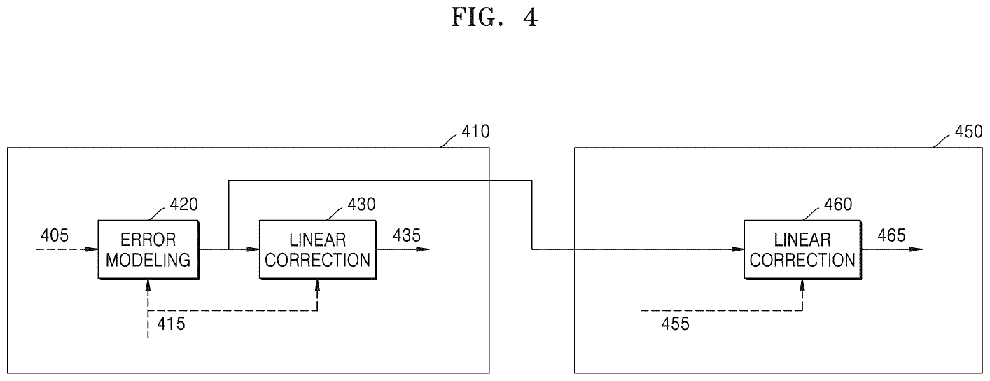

FIG. 4 is a diagram for schematically describing a process in which linear correction parameters are derived at an encoder side and transmitted to a decoder side to perform linear correction, according to an embodiment of the present disclosure.

The encoder has access to an original frame and may model encoding errors for later correction. Reconstructed frames may shrink, expand, or shift due to nonlinearities in encoder and decoder networks, and these transformations may be corrected via a linear operator using linear regression. Linear regression may be performed by performing optimization based on a mean squared error (MSE) function such as peak signal-to-noise ratio (PSNR).

Linear correction may be performed according to Equation 3 below.

$${x}_{Corrected} = α {x}_{ToBeCorrected} + β \qquad [ Equation 3 ]$$

Here, x_{ToBeCorrected} denotes a signal to be corrected, for example, a decoded frame, x_{Corrected} denotes a corrected signal assumed to have better quality, and α and β denote parameters for linear correction.

The linear correction parameters are optimized at the encoder side and then transmitted to the decoder side. A reference signal or an original signal aids in deriving the linear parameters via regression or backpropagation. The linear correction parameters may vary depending on a distortion metric (e.g., regression for MSE, backpropagation for a generative adversarial network (GAN), or using gradient descent with backpropagation).

In detail, the linear correction parameters α and β may be obtained according to Equation 4 below.

$$[ Equation 4 ]$$

$$α , β = arg min L ( {x}_{Reference} , {x}_{Corrected} ) \to α = α \vert \frac{\partial L}{θ α} = 0 ; β \vert \frac{\partial L}{\partial β} = 0$$

Here, x_{Reference} denotes a reference signal, for example, an original frame, and the L( ) function denotes a distortion metric, for example, MSE, structural similarity index measure (SSIM), or GAN.

The linear correction parameters may include a multiplicative parameter and an additive parameter, which may be transmitted to the decoder.

That is, at the encoder, the linear correction parameters are derived by using original data or the like according to Equation 4, and then transmitted to the decoder side, and at the decoder, linear correction is performed according to Equation 3.

Referring to FIG. 4, at an encoder 410, error modeling 420 is performed by using an original frame 405 and a decoded frame 415 to be corrected, linear correction 430 is performed by using linear correction parameters 425 obtain via the error modeling 420, and a corrected frame 435 is obtained as a result of the linear correction 430. The linear correction parameters 425 are transmitted to a decoder 450, via cost calculation such as sum of transform difference (SATD) or rate-distortion optimization (RDO), based on the corrected frame 435 and the linear correction parameters 425. At the decoder 450, a linearly corrected reconstructed frame 465 is obtained by applying linear correction 460 to a frame 455 that has been decoded at the decoder 450, based on the transmitted linear correction parameters 425.

In the case of FIG. 4, when the frame height is H, the frame width is W, and the number of channels is C, the number of multiplication operations and the number of addition operations are both H×W×C. For example, for a 4K sequence, 24M multiplication operations and 24M addition operations, which correspond to 3840×1980×3 (in a case in which the width is 3840, the height is 1980, and the number of channels is 3), are performed.

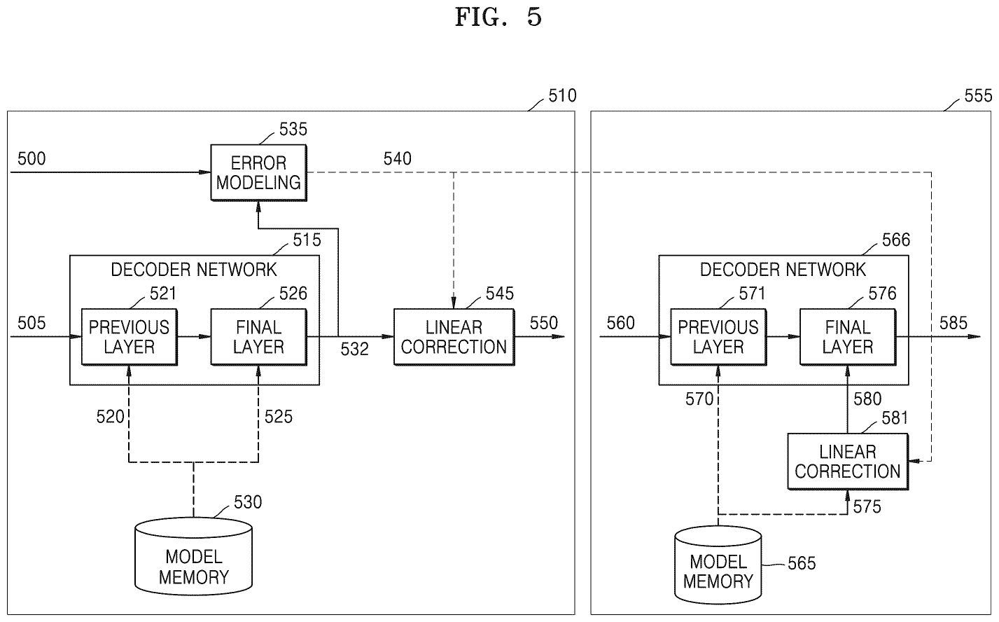

A linear correction method that reduces this number of calculations will be described with reference to FIG. 5.

FIG. 5 is a diagram for schematically describing a process in which linear correction parameters are derived at an encoder side and transmitted to a decoder side to perform linear correction, according to an embodiment of the present disclosure.

Compared to FIG. 4, FIG. 5 illustrates a method of applying linear correction to weight parameters of a final layer of a neural network.

Referring to FIG. 5, at an encoder 510, feature data 505 for a current image is applied to a decoder network 515 within the encoder 510. Previous layer parameters 520 for a previous layer 521 and final layer parameters 525 for a final layer 526 of the decoder network 515 are obtained from a model memory 530 of a learning model. A decoded frame 532 to be corrected is obtained by applying the feature data 505 for the current image sequentially to the previous layer parameters 520 and the final layer parameters 525 of the decoder network 515. Linear correction parameters 540 are obtained by performing error modeling 535 is performed based on an original frame 500 of the current image and the decoded frame 532. Linear correction 545 is performed by using the linear correction parameters 540, and a corrected frame 550 is obtained as a result of the linear correction 545. The feature data 505 for the current image and the linear correction parameters 540 are transmitted to a decoder 555 via cost calculation such as SATD or RDO, based on the corrected frame 550 and the linear correction parameters 540. At the decoder 555, feature data 560 for the current image and the linear correction parameters 540 are obtained from a bitstream, and previous layer parameters 570 for a previous layer 571 and final layer parameters 575 for a final layer 576 of a decoder network 566 are obtained from a model memory 565. Linearly corrected final layer parameters 580 are obtained by performing linear correction 581 based on the final layer parameters 575 and the linear correction parameters 540. A linearly corrected reconstructed frame 585 is obtained by applying the feature data 560 for the current image sequentially to the previous layer parameters 570 and the linearly corrected final layer parameters 580.

In detail, a process in which the linear correction 581 is performed on the final layer parameters 575 is as follows.

Assume that, in the decoder network 566, the feature data 560 for the current image is x, the previous layer parameters 570 are wₙ and bₙ, and n is 1 to (N−1) and denotes the n-th layer, a first output feature map y₁ is obtained at the first layer according to Equation 5 below.

$${y}_{1} = {w}_{1} * x + {b}_{1} \qquad [ Equation 5 ]$$

Subsequently, at the n-th layer, an n-th output feature map yₙ is obtained according to Equation 6 below.

$${y}_{n} = {W}_{n} * {y}_{n - 1} + {b}_{n} \qquad [ Equation 6 ]$$

At the N-th layer, which is the final layer, a final output feature map yN may be obtained according to Equation 7 below.

$${y}_{N} = {w}_{N} * {y}_{N - 1} + {b}_{N} \qquad [ Equation 7 ]$$

The linear correction 581 of the final layer parameters 575 is performed on the parameters w_{N} and b_{N} of the final layer. In detail, the linear correction is applied according to Equation 8 below.

$$[ Equation 8 ]$$

$${y}_{N} = a ( {w}_{N} * {y}_{N - 1} + {b}_{N} ) + β = a {w}_{N} * {y}_{N - 1} + a {b}_{N} + β = ( a {w}_{N} ) * {y}_{N - 1} + ( a {b}_{N} + β ) = {w}_{N}^{′} * {y}_{N - 1} + {b}_{N}^{′}$$

That is, among the linearly corrected final layer parameters 580, the parameter W′_{N} is α W_{N}, and the parameter b′_{N} is α b_{N}+β.

As such, the linear correction 581 for the final layer parameters 575 is a process of obtaining the linearly corrected final layer parameters 580 that has been modified by applying the linear correction parameters 540 to the final layer parameters 575. That is, the linear correction 581 is performed by merging the linear correction parameters 540 with the final layer parameters 575.

By using the previous layer parameters 570 and the linearly corrected final layer parameters 580 of the decoder network 566 of the decoder 555, the linearly corrected reconstructed frame 585, which reflects the linear correction, is obtained.

Although the decoder network 515 of the encoder 510 and the decoder network 566 of the decoder 555 are identical neural network-based decoder networks, they differ in that linear correction is performed on the final layer parameters of the decoder network 566 of the decoder 555, and the linearly corrected final layer parameters are then applied.

In this case, at the encoder, linear correction is performed on a frame basis as in FIG. 4, whereas, at the decoder, linear correction is performed on the final layer of the neural network, and thus, the number of multiplication calculations performed is K×K×Cₗₐₛₜ×C, and the number of addition calculations performed is equal to the number C of channels of the current image. Here, K×K denotes the size of a filter kernel, and Cₗₐₛₜ denotes the number of channels of the final layer. For example, when the current image has 3 channels, and the kernel of the neural network is a 5×5 kernel, the number of addition calculations performed may be 3, and the number of multiplication calculations performed may be 5×5×Cₗₐₛₜ×3. When Cₗₐₛₜ is 133, approximately 10K multiplication calculations may be performed for a 4K image.

When the linear correction at the decoder in FIG. 4 is referred to as large linear correction and the linear correction at the decoder in FIG. 5 is referred to as small linear correction, in general, for high-resolution frames, the small linear correction is always more efficient than the large linear correction. However, it may be difficult to apply the small linear correction depending on the type of operator used in the final layer of the neural network. In addition, although rare, cases may occur where the frame resolution is relatively much smaller than the number of weights in the final layer. In such cases, the large linear correction may be applied.

Linear correction may be performed on a frame basis, on a block basis, or individually for each color component such as luma or chroma components within color spaces like RGB or YUV.

Whether to apply linear correction in frame units, lower level units, block units, or the like may be selected via RDO considering overhead. For example, the determination of whether to apply linear correction may be made for frames, for color components, and for blocks. Through this approach, image quality may be sufficiently improved for overhead data.

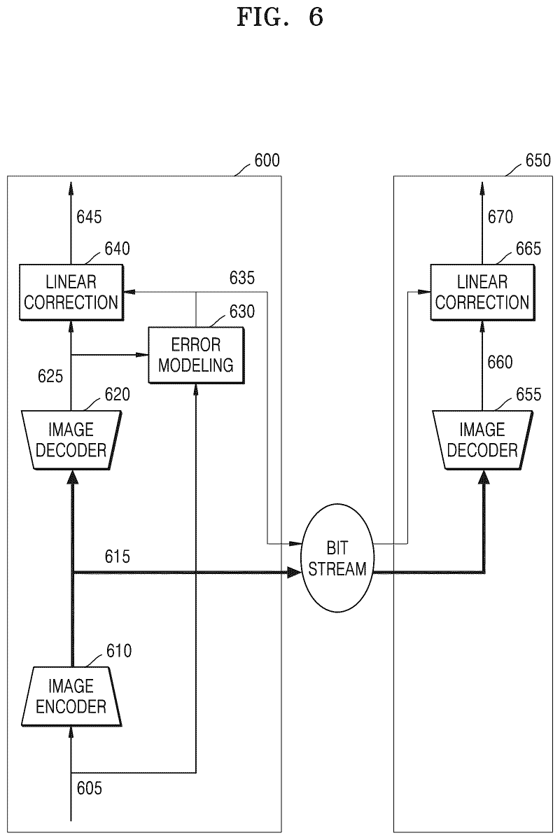

FIG. 6 is a diagram illustrating a process in which linear correction is performed in intra prediction, according to an embodiment of the present disclosure.

Referring to FIG. 6, in intra prediction, as linear correction is additionally performed, the efficiency and image quality of the intra prediction may be improved. In detail, at an encoder 600, a current original frame 605 is input to a neural network-based image encoder 610, to obtain feature data 615 for the current original frame 605. The feature data 615 is input to a neural network-based image decoder 620, to obtain a decoded frame 625 for the current original frame 605. Linear correction parameters 635 are obtained by performing error modeling 630 based on the decoded frame 625 and the current original frame 605. A reconstructed frame 645 for the current original frame 605 is obtained by performing linear correction 640 based on the decoded frame 625 and the linear correction parameters 635. The feature data 615 for the current image and the linear correction parameters 635 are transmitted to a decoder 650 via cost calculation such as SATD or RDO, based on the reconstructed frame 645 and the linear correction parameters 635.

The decoder 650 obtains the feature data 615 and the linear correction parameters 635 from a bitstream. The feature data 615 is input to a neural network-based image decoder 655 to obtain a decoded frame 660, and linear correction 665 is performed based on the decoded frame 660 and the linear correction parameters 635 to obtain a reconstructed frame 670.

The image decoder 620 of the encoder 600 and the image decoder 655 of the decoder 650 are identical image decoders.

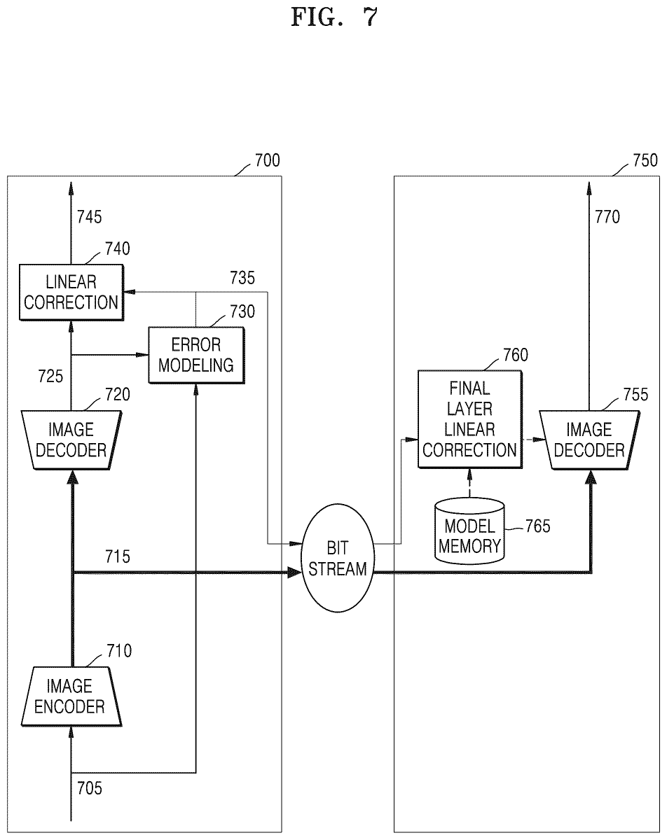

FIG. 7 is a diagram illustrating a process in which linear correction is performed in intra prediction, according to an embodiment of the present disclosure.

Referring to FIG. 7, in intra prediction, as linear correction is additionally performed, the efficiency and image quality of the intra prediction may be improved. In detail, at an encoder 700, a current original frame 705 is input to a neural network-based image encoder 710, to obtain feature data 715 for the current original frame 705. The feature data 715 is input to a neural network-based image decoder 720, to obtain a decoded frame 725 for the current original frame 705. Linear correction parameters 735 are obtained by performing error modeling 730 based on the decoded frame 725 and the current original frame 705. A reconstructed frame 745 for the current original frame 705 is obtained by performing linear correction 740 based on the decoded frame 725 and the linear correction parameters 735. The feature data 715 for the current image and the linear correction parameters 735 are transmitted to a decoder 750 via cost calculation such as SATD or RDO, based on the reconstructed frame 745 and the linear correction parameters 735.

The decoder 750 obtains the feature data 715 and the linear correction parameters 735 from a bitstream. Parameters for a neural network of a neural network-based image decoder 755 are obtained from a model memory 765, and final layer linear correction 760 is performed on final layer parameters of the neural network among the obtained parameters by using the linear correction parameters 735, to obtain previous layer parameters and linearly corrected final layer parameters for the image decoder 755. The feature data 715 is input to the image decoder 755 to which neural network parameters including the previous layer parameters and the linearly corrected final layer parameters are applied, to obtain a reconstructed current frame 770 to which linear correction is applied.

Although the image decoder 720 of the encoder 700 and the image decoder 755 of the decoder 750 are identical image decoders, they differ in that linear correction is performed on the final layer parameters of the image decoder 755 of the decoder 750, such that the linearly corrected final layer parameters are applied.

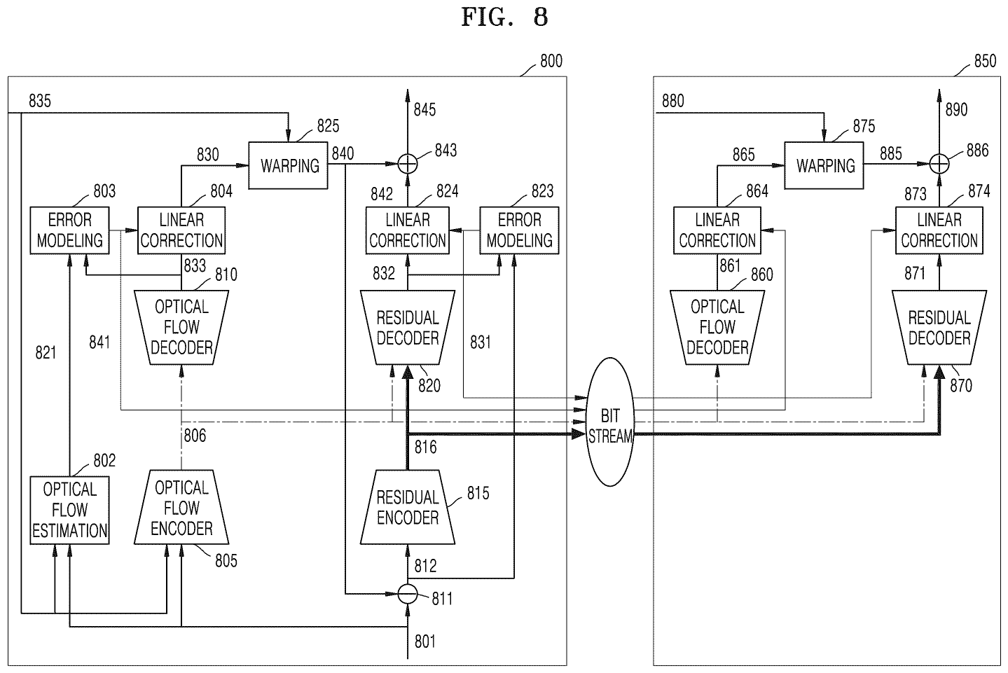

FIG. 8 is a diagram illustrating a process in which linear correction is performed in inter prediction, according to an embodiment of the present disclosure.

Referring to FIG. 8, in inter prediction, as linear correction is additionally performed, the efficiency and image quality of the inter prediction may be improved. In detail, at an encoder 800, a current original frame 801 and a previous reconstructed frame 835 are input to a neural network-based optical flow encoder 805, to obtain feature data 806 for an optical flow of the current original frame 801. The feature data 806 for the optical flow is input to a neural network-based optical flow decoder 810, to obtain a decoded optical flow 833. Optical flow estimation 802 is performed based on the current original frame 801 and the previous reconstructed frame 835, to obtain a frame-based optical flow 821. Error modeling 803 is performed based on the decoded optical flow 833, which is obtained via the neural network, and the frame-based optical flow 821, to obtain linear correction parameters 841 for the optical flow. Linear correction 804 is performed based on the linear correction parameters 841 and the decoded optical flow 833, to obtain a reconstructed optical flow 830. A current predicted frame 840 for the current original frame 801 is obtained by performing warping 825 using the reconstructed optical flow 830 and the previous reconstructed frame 835. A residual frame 812 for the current original frame 801 is obtained by subtracting 811 the current predicted frame 840 from the current original frame 801. The residual frame 812 is input to a neural network-based residual encoder 815, to obtain feature data 816 for the residual frame 812. The feature data 806 for the optical flow and the feature data 816 for the residual frame 812 are input to a residual decoder 820, to obtain a decoded residual frame 832. The feature data 806 for the optical flow and the feature data 816 for the residual frame 812 are concatenated with each other before being input. Error modeling 823 is performed based on the residual frame 812 and the decoded residual frame 832, to obtain linear correction parameters 831 for the residual frame. Linear correction 824 is performed based on the decoded residual frame 832 and the linear correction parameters 831, to obtain a reconstructed residual frame 842. A reconstructed current frame 845 is obtained by summing 843 the current predicted frame 840 and the reconstructed residual frame 842. The feature data 806 for the optical flow of the current frame, the feature data 816 for the residual frame 812 of the current frame, the linear correction parameters 841 for the optical flow, and the linear correction parameters 831 for the residual frame are transmitted to a decoder 850 via cost calculation such as SATD or RDO, based on the reconstructed current frame 845, the linear correction parameters 841 for the optical flow, and the linear correction parameters 831 for the residual frame.

The decoder 850 obtains, from a bitstream, the feature data 806 for the optical flow of the current frame, the feature data 816 for the residual frame 812 of the current frame, the linear correction parameters 841 for the optical flow, and the linear correction parameters 831 for the residual frame. The feature data 806 for the optical flow is input to a neural network-based optical flow decoder 860, to obtain a decoded optical flow 861. A final reconstructed optical flow 865 is obtained by performing linear correction 864 based on the decoded optical flow 861 and the linear correction parameters 841 for the optical flow. A current predicted frame 885 is obtained by performing warping 875 based on the final reconstructed optical flow 865 and a previous reconstructed frame 880. In addition, the feature data 806 for the optical flow of the current frame and the feature data 816 for the residual frame 812 of the current frame are input to a residual decoder 870, to obtain a decoded residual frame 871. The feature data 806 for the optical flow and the feature data 816 for the residual frame 812 are concatenated with each other before being input. A final reconstructed residual frame 873 is obtained by performing linear correction 874 based on the decoded residual frame 871 and the linear correction parameters 831 for the residual frame. A reconstructed current frame 890 is obtained by summing 886 the current predicted frame 885 and the final reconstructed residual frame 873.

The previous reconstructed frame 835 at the encoder 800 and the previous reconstructed frame 880 at the decoder 850 are identical to each other, and the optical flow decoder 810 and the residual decoder 820 of the encoder 800 are identical to the optical flow decoder 860 and the residual decoder 870 of the decoder 850, respectively.

According to an embodiment, linear correction may be applied only to the optical flow. In detail, at the encoder 800, the error modeling 803 may be performed only on the decoded optical flow 833 to obtain the linear correction parameters 841 for the optical flow, and then the linear correction 804 may be performed, and the error modeling 823 may not be performed on the decoded residual frame 832, and the decoded residual frame 832 may be summed 843 with the predicted frame 840 to obtain the reconstructed current frame 845. In addition, when the error modeling 823 is performed on the decoded residual frame 832 but the linear correction 824 is unnecessary (e.g., unnecessary due to cost calculation such as SATD or RDO), the decoded residual frame 832 may be summed 843 with the predicted frame 840 to obtain the reconstructed current frame 845.

The encoder 800 may transmit, to the decoder 850, the feature data 806 for the optical flow of the current frame, the feature data 816 for the residual frame 812 of the current frame, and the linear correction parameters 841 for the optical flow.

The decoder 850 may obtain, from a bitstream, the feature data 806 for the optical flow of the current frame, the feature data 816 for the residual frame 812 of the current frame, and the linear correction parameters 841 for the optical flow. The feature data 806 for the optical flow may be input to the neural network-based optical flow decoder 860 to obtain the decoded optical flow 861, and the linear correction 864 may be performed based on the decoded optical flow 861 and the linear correction parameters 841 for the optical flow, to obtain the final reconstructed optical flow 865. The current predicted frame 885 may be obtained by performing the warping 875 based on the final reconstructed optical flow 865 and the previous reconstructed frame 880. In addition, the feature data 806 for the optical flow of the current frame and the feature data 816 for the residual frame 812 of the current frame may be input to the residual decoder 870, to obtain the decoded residual frame 871. The feature data 806 for the optical flow and the feature data 816 for the residual frame 812 may be concatenated with each other before being input. The reconstructed current frame 890 may be obtained by summing 886 the current predicted frame 885 and the decoded residual frame 871.

According to an embodiment, linear correction may be applied only to the decoded residual frame 832. In detail, at the encoder 800, the error modeling 823 may be performed only on the decoded residual frame 832 to obtain the linear correction parameters 831 for the residual frame, and then the linear correction 824 may be performed, and the error modeling 803 may not be performed on the decoded optical flow 833, and the warping 825 may be performed based on the decoded optical flow 833 and the previous reconstructed frame 835, to obtain the current predicted frame 840. In addition, when the error modeling 803 is performed on the decoded optical flow 833 but the linear correction 804 is unnecessary (e.g., unnecessary due to cost calculation such as SATD or RDO), the current predicted frame 840 may be obtained by performing the warping 825 based on the decoded optical flow 833 and the previous reconstructed frame 835.

The encoder 800 may transmit, to the decoder 850, the feature data 806 for the optical flow of the current frame, the feature data 816 for the residual frame 812 of the current frame, and the linear correction parameters 831 for the residual frame.

The decoder 850 may obtain, from a bitstream, the feature data 806 for the optical flow of the current frame, the feature data 816 for the residual frame 812 of the current frame, and the linear correction parameters 831 for the residual frame. The feature data 806 for the optical flow may be input to the neural network-based optical flow decoder 860 to obtain the decoded optical flow 861, and the warping 875 may be performed based on the decoded optical flow 861 and the previous reconstructed frame 880, to obtain the current predicted frame 885. In addition, the feature data 806 for the optical flow of the current frame and the feature data 816 for the residual frame 812 of the current frame may be input to the residual decoder 870, to obtain the decoded residual frame 871. The feature data 806 for the optical flow and the feature data 816 for the residual frame 812 may be concatenated with each other before being input. The final reconstructed residual frame 873 may be obtained by performing the linear correction 874 based on the decoded residual frame 871 and the linear correction parameters 831 for the residual frame. The reconstructed current frame 890 may be obtained by summing 886 the current predicted frame 885 and the final reconstructed residual frame 873.

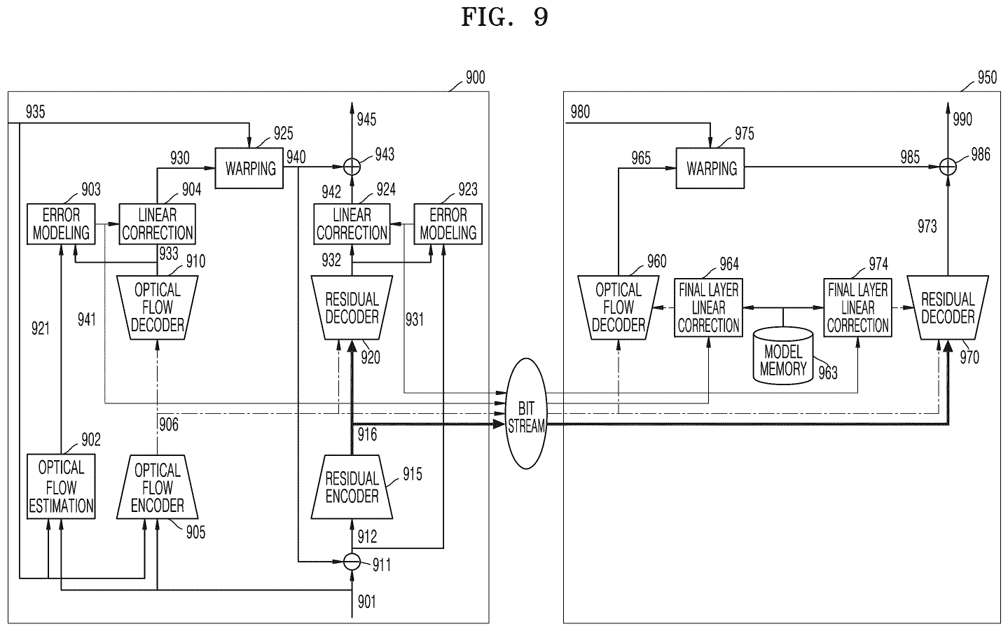

FIG. 9 is a diagram illustrating a process in which linear correction is performed in inter prediction, according to an embodiment of the present disclosure.

Referring to FIG. 9, in inter prediction, as linear correction is additionally performed, the efficiency and image quality of the inter prediction may be improved. In detail, at an encoder 900, a current original frame 901 and a previous reconstructed frame 935 are input to a neural network-based optical flow encoder 905, to obtain feature data 906 for an optical flow of the current original frame 901. The feature data 906 for the optical flow is input to a neural network-based optical flow decoder 910, to obtain a decoded optical flow 933. Optical flow estimation 902 is performed based on the current original frame 901 and the previous reconstructed frame 935, to obtain a frame-based optical flow 921. Error modeling 903 is performed based on the decoded optical flow 933, which is obtained via the neural network, and the frame-based optical flow 921, to obtain linear correction parameters 941 for the optical flow. Linear correction 904 is performed based on the linear correction parameters 941 and the decoded optical flow 933, to obtain a reconstructed optical flow 930. A current predicted frame 940 for the current original frame 901 is obtained by performing warping 925 using the reconstructed optical flow 930 and the previous reconstructed frame 935. A residual frame 912 for the current original frame 901 is obtained by subtracting 911 the current predicted frame 940 from the current original frame 901. The residual frame 912 is input to a neural network-based residual encoder 915, to obtain feature data 916 for the residual frame 912. The feature data 906 for the optical flow and the feature data 916 for the residual frame 912 are input to a residual decoder 920, to obtain a decoded residual frame 932. The feature data 906 for the optical flow and the feature data 916 for the residual frame 912 are concatenated with each other before being input. Error modeling 923 is performed based on the residual frame 912 and the decoded residual frame 932, to obtain linear correction parameters 931 for the residual frame. Linear correction 924 is performed based on the decoded residual frame 932 and the linear correction parameters 931, to obtain a reconstructed residual frame 942. A reconstructed current frame 945 is obtained by summing 943 the current predicted frame 940 and the reconstructed residual frame 942. The feature data 906 for the optical flow of the current frame, the feature data 916 for the residual frame 912 of the current frame, the linear correction parameters 941 for the optical flow, and the linear correction parameters 931 for the residual frame are transmitted to a decoder 950 via cost calculation such as SATD or RDO, based on the reconstructed current frame 945, the linear correction parameters 941 for the optical flow, and the linear correction parameters 931 for the residual frame.

The decoder 950 obtains, from a bitstream, the feature data 906 for the optical flow of the current frame, the feature data 916 for the residual frame 912 of the current frame, the linear correction parameters 941 for the optical flow, and the linear correction parameters 931 for the residual frame. Parameters for a neural network of a neural network-based optical flow decoder 960 are obtained from a model memory 963, and final layer linear correction 964 is performed on final layer parameters of the neural network among the obtained parameters by using the linear correction parameters 941 for the optical flow, to obtain previous layer parameters and linearly corrected final layer parameters for the optical flow decoder 960. The feature data 906 for the optical flow of the current frame is input to the optical flow decoder 960 to which neural network parameters including the previous layer parameters and the linearly corrected final layer parameters are applied, to obtain a final reconstructed optical flow 965 to which linear correction is applied. A current predicted frame 985 is obtained by performing warping 975 based on the final reconstructed optical flow 965 and a previous reconstructed frame 980. In addition, parameters for a neural network of a neural network-based residual decoder 970 are obtained from the model memory 963, and final layer linear correction 974 is performed on final layer parameters of the neural network among the obtained parameters by using the linear correction parameters 931 for the residual frame, to obtain previous layer parameters and linearly corrected final layer parameters for the residual decoder 970. The feature data 906 for the optical flow of the current frame and the feature data 916 for the residual frame 912 of the current frame are input to the residual decoder 970 to which neural network parameters including the previous layer parameters and the linearly corrected final layer parameters are applied, to obtain a reconstructed residual frame 973 to which linear correction is applied. The feature data 906 for the optical flow of the current frame and the feature data 916 for the residual frame 912 of the current frame are concatenated with each other before being input. A final reconstructed current frame 990 is obtained by summing 986 the current predicted frame 985 and the reconstructed residual frame 973.

The previous reconstructed frame 935 at the encoder 900 and the previous reconstructed frame 980 at the decoder 950 are identical to each other.

The optical flow decoder 910 and the residual decoder 920 of the encoder 900 are identical to the optical flow decoder 960 and the residual decoder 970 of the decoder 950, respectively, but they differ in that linear correction is performed on the final layer parameters for the optical flow decoder 960 and the residual decoder 970 of the decoder 950, and then the linearly corrected final layer parameters are applied.

According to an embodiment, linear correction may be applied only to the optical flow. In detail, at the encoder 900, the error modeling 903 may be performed only on the decoded optical flow 933 to obtain the linear correction parameters 941 for the optical flow, and then the linear correction 904 may be performed, and the error modeling 923 may not be performed on the decoded residual frame 932, and the decoded residual frame 932 may be summed 943 with the predicted frame 940 to obtain the reconstructed current frame 945. In addition, when the error modeling 923 is performed on the decoded residual frame 932 but the linear correction 924 is unnecessary (e.g., unnecessary due to cost calculation such as SATD or RDO), the decoded residual frame 932 may be summed 943 with the predicted frame 940 to obtain the reconstructed current frame 945.

The encoder 900 may transmit, to the decoder 950, the feature data 906 for the optical flow of the current frame, the feature data 916 for the residual frame 912 of the current frame, and the linear correction parameters 941 for the optical flow.

The decoder 950 may obtain, from a bitstream, the feature data 906 for the optical flow of the current frame, the feature data 916 for the residual frame 912 of the current frame, and the linear correction parameters 941 for the optical flow. Parameters for a neural network of the neural network-based optical flow decoder 960 may be obtained from the model memory 963, and the final layer linear correction 964 may be performed on final layer parameters of the neural network among the obtained parameters by using the linear correction parameters 941 for the optical flow, to obtain previous layer parameters and linearly corrected final layer parameters for the optical flow decoder 960. The feature data 906 for the optical flow of the current frame may be input to the optical flow decoder 960 to which neural network parameters including the previous layer parameters and the linearly corrected final layer parameters are applied, to obtain the final reconstructed optical flow 965 to which linear correction is applied. The current predicted frame 985 may be obtained by performing the warping 975 based on the final reconstructed optical flow 965 and the previous reconstructed frame 980. In addition, parameters for a neural network of the neural network-based residual decoder 970 may be obtained from the model memory 963, and the feature data 906 for the optical flow of the current frame and the feature data 916 for the residual frame 912 of the current frame may be input to the neural network-based residual decoder 970, to obtain the reconstructed residual frame 973. Here, the reconstructed residual frame 973 is a residual frame to which linear correction is not applied. The feature data 906 for the optical flow of the current frame and the feature data 916 for the residual frame 912 of the current frame may be concatenated with each other before being input. The final reconstructed current frame 990 may be obtained by summing 986 the current predicted frame 985 and the reconstructed residual frame 973.

According to an embodiment, linear correction may be applied only to the decoded residual frame 932. In detail, at the encoder 900, the error modeling 923 may be performed only on the decoded residual frame 932 to obtain the linear correction parameters 931 for the residual frame, and then the linear correction 924 may be performed, and the error modeling 903 may not be performed on the decoded optical flow 933, and the warping 925 may be performed based on the decoded optical flow 933 and the previous reconstructed frame 935, to obtain the current predicted frame 940. In addition, when the error modeling 903 is performed on the decoded optical flow 933 but the linear correction 904 is unnecessary (e.g., unnecessary due to cost calculation such as SATD or RDO), the current predicted frame 940 may be obtained by performing the warping 925 based on the decoded optical flow 933 and the previous reconstructed frame 935.

The encoder 900 may transmit, to the decoder 950, the feature data 906 for the optical flow of the current frame, the feature data 916 for the residual frame 912 of the current frame, and the linear correction parameters 931 for the residual frame.

The decoder 950 may obtain, from a bitstream, the feature data 906 for the optical flow of the current frame, the feature data 916 for the residual frame 912 of the current frame, and the linear correction parameters 931 for the residual frame. Parameters of the neural network of the neural network-based optical flow decoder 960 may be obtained from the model memory 963, and the feature data 906 for the optical flow of the current frame may be input to the neural network-based optical flow decoder 960, to obtain the reconstructed optical flow 965. Here, the reconstructed optical flow 965 is an optical flow to which linear correction is not applied. The current predicted frame 985 may be obtained by performing the warping 975 based on the reconstructed optical flow 965 and the previous reconstructed frame 980. In addition, parameters for a neural network of the neural network-based residual decoder 970 may be obtained from the model memory 963, and the final layer linear correction 974 may be performed on final layer parameters of the neural network among the obtained parameters by using the linear correction parameters 931 for the residual frame, to obtain previous layer parameters and linearly corrected final layer parameters for the residual decoder 970. The feature data 906 for the optical flow of the current frame and the feature data 916 for the residual frame 912 of the current frame may be input to the residual decoder 970 to which neural network parameters including the previous layer parameters and the linearly corrected final layer parameters are applied, to obtain the reconstructed residual frame 973 to which linear correction is applied. The feature data 906 for the optical flow of the current frame and the feature data 916 for the residual frame 912 of the current frame may be concatenated with each other before being input. The final reconstructed current frame 990 may be obtained by summing 986 the current predicted frame 985 and the reconstructed residual frame 973.

In addition, according to an embodiment, linear correction may be applied to the optical flow, while final layer linear correction may be applied to the residual frame. In detail, as described above with reference to FIGS. 8 and 9, at the encoder 800 or 900, the feature data 806 or 906 for the optical flow of the current frame, the feature data 816 or 916 for the residual frame 812 or 912 of the current frame, the linear correction parameters 841 or 941 for the optical flow, and the linear correction parameters 831 or 931 for the residual frame may be obtained and transmitted to the decoder 850 or 950.

The decoder 850 or 950 may obtain, from a bitstream, the feature data 806 or 906 for the optical flow of the current frame, the feature data 816 or 916 for the residual frame 812 or 912 of the current frame, the linear correction parameters 841 or 941 for the optical flow, and the linear correction parameters 831 or 931 for the residual frame. The feature data 806 or 906 for the optical flow may be input to the neural network-based optical flow decoder 860 or 960, to obtain the decoded optical flow 861 or 961. The final reconstructed optical flow 865 may be obtained by performing the linear correction 864 based on the decoded optical flow 861 and the linear correction parameters 841 or 941 for the optical flow. The current predicted frame 885 may be obtained by performing the warping 875 based on the final reconstructed optical flow 865 and the previous reconstructed frame 880. In addition, the feature data 806 or 906 for the optical flow of the current frame and the feature data 816 or 916 for the residual frame 812 or 912 of the current frame may be input to the residual decoder 870 or 970, to obtain the decoded residual frame 871. The feature data 806 or 906 for the optical flow and the feature data 816 or 916 for the residual frame 812 or 912 are concatenated with each other before being input. Parameters for a neural network of the neural network-based residual decoder 970 may be obtained from the model memory 963, and the final layer linear correction 974 may be performed on final layer parameters of the neural network among the obtained parameters by using the linear correction parameters 831 or 931 for the residual frame, to obtain previous layer parameters and linearly corrected final layer parameters for the residual decoder 970. The feature data 806 or 906 for the optical flow of the current frame and the feature data 816 or 916 for the residual frame 812 or 912 of the current frame may be input to the residual decoder 970 to which neural network parameters including the previous layer parameters and the linearly corrected final layer parameters are applied, to obtain the reconstructed residual frame 973 to which linear correction is applied. The feature data 806 or 906 for the optical flow of the current frame and the feature data 816 or 916 for the residual frame 812 or 912 of the current frame may be concatenated with each other before being input. The final reconstructed current frame 890 or 990 may be obtained by summing 886 or 986 the current predicted frame 885 or 985 and the reconstructed residual frame 873 or 973.

In addition, according to an embodiment, final layer linear correction may be applied to the optical flow, while linear correction may be applied to the residual frame. In detail, as described above with reference to FIGS. 8 and 9, at the encoder 800 or 900, the feature data 806 or 906 for the optical flow of the current frame, the feature data 816 or 916 for the residual frame 812 or 912 of the current frame, the linear correction parameters 841 or 941 for the optical flow, and the linear correction parameters 831 or 931 for the residual frame may be obtained and transmitted to the decoder 850 or 950.

The decoder 850 or 950 may obtain, from a bitstream, the feature data 806 or 906 for the optical flow of the current frame, the feature data 816 or 916 for the residual frame 812 or 912 of the current frame, the linear correction parameters 841 or 941 for the optical flow, and the linear correction parameters 831 or 931 for the residual frame. Parameters for a neural network of the neural network-based optical flow decoder 960 may be obtained from the model memory 963, and the final layer linear correction 964 may be performed on final layer parameters of the neural network among the obtained parameters by using the linear correction parameters 941 for the optical flow, to obtain previous layer parameters and linearly corrected final layer parameters for the optical flow decoder 960. The feature data 806 or 906 for the optical flow of the current frame may be input to the optical flow decoder 960 to which neural network parameters including the previous layer parameters and the linearly corrected final layer parameters are applied, to obtain the final reconstructed optical flow 965 to which linear correction is applied. The current predicted frame 885 or 985 may be obtained by performing the warping 975 based on the final reconstructed optical flow 965 and the previous reconstructed frame 980. In addition, the final reconstructed residual frame 873 or 973 may be obtained by performing the linear correction 874 based on the decoded residual frame 871 and the linear correction parameters 831 or 931 for the residual frame. The reconstructed current frame 890 or 990 may be obtained by summing 886 or 986 the current predicted frame 885 or 985 and the final reconstructed residual frame 873 or 973.

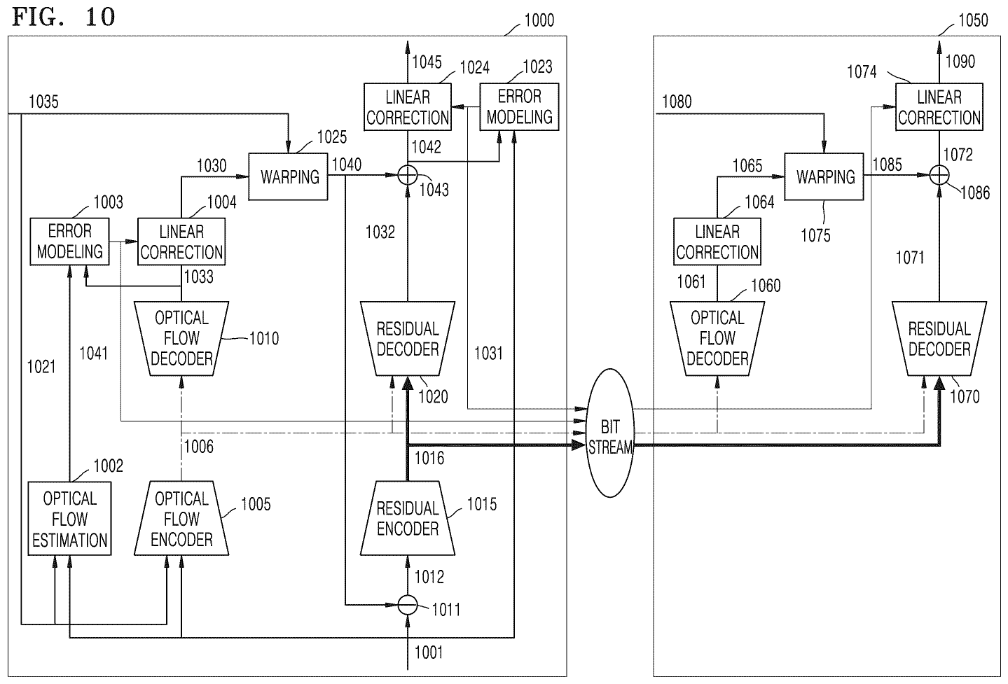

FIG. 10 is a diagram illustrating a process in which linear correction is performed in inter prediction, according to an embodiment of the present disclosure.

Referring to FIG. 10, in inter prediction, as linear correction is additionally performed, the efficiency and image quality of the inter prediction may be improved. In detail, at an encoder 1000, a current original frame 1001 and a previous reconstructed frame 1035 are input to a neural network-based optical flow encoder 1005, to obtain feature data 1006 for an optical flow of the current original frame 1001. The feature data 1006 for the optical flow is input to a neural network-based optical flow decoder 1010, to obtain a decoded optical flow 1033. Optical flow estimation 1002 is performed based on the current original frame 1001 and the previous reconstructed frame 1035, to obtain a frame-based optical flow 1021. Error modeling 1003 is performed based on the decoded optical flow 1033, which is obtained via the neural network, and the frame-based optical flow 1021, to obtain linear correction parameters 1041 for the optical flow. Linear correction 1004 is performed based on the linear correction parameters 1041 and the decoded optical flow 1033, to obtain a reconstructed optical flow 1030. A current predicted frame 1040 for the current original frame 1001 is obtained by performing warping 1025 using the reconstructed optical flow 1030 and the previous reconstructed frame 1035. A residual frame 1012 for the current original frame 1001 is obtained by subtracting 1011 the current predicted frame 1040 from the current original frame 1001. The residual frame 1012 is input to a neural network-based residual encoder 1015, to obtain feature data 1016 for the residual frame 1012. The feature data 1006 for the optical flow and the feature data 1016 for the residual frame 1012 are input to a residual decoder 1020, to obtain a decoded residual frame 1032. The feature data 1006 for the optical flow and the feature data 1016 for the residual frame 1012 are concatenated with each other before being input. A decoded current frame 1042 is obtained by summing 1043 the decoded residual frame 1032 and the current predicted frame 1040. Error modeling 1023 is performed based on the current original frame 1001 and the decoded current frame 1042, to obtain linear correction parameters 1031 for the current frame. Linear correction 1024 is performed based on the decoded current frame 1042 and the linear correction parameters 1031, to obtain a final reconstructed current frame 1045. The feature data 1006 for the optical flow of the current frame, the feature data 1016 for the residual frame 1012 of the current frame, the linear correction parameters 1041 for the optical flow, and the linear correction parameters 1031 for the current frame are transmitted to a decoder 1050 via cost calculation such as SATD or RDO, based on the reconstructed current frame 1045, the linear correction parameters 1041 for the optical flow, and the linear correction parameters 1031 for the current frame.

The decoder 1050 obtains, from a bitstream, the feature data 1006 for the optical flow of the current frame, the feature data 1016 for the residual frame 1012 of the current frame, the linear correction parameters 1041 for the optical flow, and the linear correction parameters 1031 for the current frame. The feature data 1006 for the optical flow is input to a neural network-based optical flow decoder 1060, to obtain a decoded optical flow 1061. A final reconstructed optical flow 1065 is obtained by performing linear correction 1064 based on the decoded optical flow 1061 and the linear correction parameters 1041 for the optical flow. A current predicted frame 1085 is obtained by performing warping 1075 based on the final reconstructed optical flow 1065 and a previous reconstructed frame 1080. In addition, the feature data 1006 for the optical flow of the current frame and the feature data 1016 for the residual frame 1012 of the current frame are input to a neural network-based residual decoder 1070, to obtain a decoded residual frame 1071. The feature data 1006 for the optical flow of the current frame and the feature data 1016 for the residual frame 1012 of the current frame are concatenated with each other before being input. A decoded current frame 1072 is obtained by summing 1086 the decoded residual frame 1071 and the current predicted frame 1085. A final reconstructed current frame 1090 is obtained by performing linear correction 1074 based on the decoded current frame 1072 and the linear correction parameters 1031 for the current frame.

The previous reconstructed frame 1035 at the encoder 1000 and the previous reconstructed frame 1080 at the decoder 1050 are identical to each other, and the optical flow decoder 1010 and the residual decoder 1020 of the encoder 1000 are identical to the optical flow decoder 1060 and the residual decoder 1070 of the decoder 1050, respectively.

According to an embodiment, linear correction may be applied only to the decoded current frame 1042. In detail, at the encoder 1000, the error modeling 1023 may be performed only on the decoded current frame 1042 to obtain the linear correction parameters 1031 for the current frame, and then the linear correction 1024 may be performed, and the error modeling 1003 may not be performed on the decoded optical flow 1033, and the warping 1025 may be performed based on the decoded optical flow 1033 and the previous reconstructed frame 1035, to obtain the current predicted frame 1040. In addition, when the error modeling 1003 is performed on the decoded optical flow 1033 but the linear correction 1004 is unnecessary (e.g., unnecessary due to cost calculation such as SATD or RDO), the current predicted frame 1040 may be obtained by performing the warping 1025 based on the decoded optical flow 1033 and the previous reconstructed frame 1035.

The encoder 1000 may transmit, to the decoder 1050, the feature data 1006 for the optical flow of the current frame, the feature data 1016 for the residual frame 1012 of the current frame, and the linear correction parameters 1031 for the current frame.

The decoder 1050 may obtain, from a bitstream, the feature data 1006 for the optical flow of the current frame, the feature data 1016 for the residual frame 1012 of the current frame, and the linear correction parameters 1031 for the current frame. The feature data 1006 for the optical flow may be input to the neural network-based optical flow decoder 1060, to obtain the decoded optical flow 1061. Here, the decoded optical flow 1061 is an optical flow on which linear correction is not performed. The current predicted frame 1085 may be obtained by performing the warping 1075 based on the decoded optical flow 1061 and the previous reconstructed frame 1080. In addition, the feature data 1006 for the optical flow of the current frame and the feature data 1016 for the residual frame 1012 of the current frame may be input to the neural network-based residual decoder 1070, to obtain the decoded residual frame 1071. The feature data 1006 for the optical flow of the current frame and the feature data 1016 for the residual frame 1012 of the current frame may be concatenated with each other before being input. The decoded current frame 1072 may be obtained by summing 1086 the decoded residual frame 1071 and the current predicted frame 1085. The final reconstructed current frame 1090 may be obtained by performing the linear correction 1074 based on the decoded current frame 1072 and the linear correction parameters 1031 for the current frame.

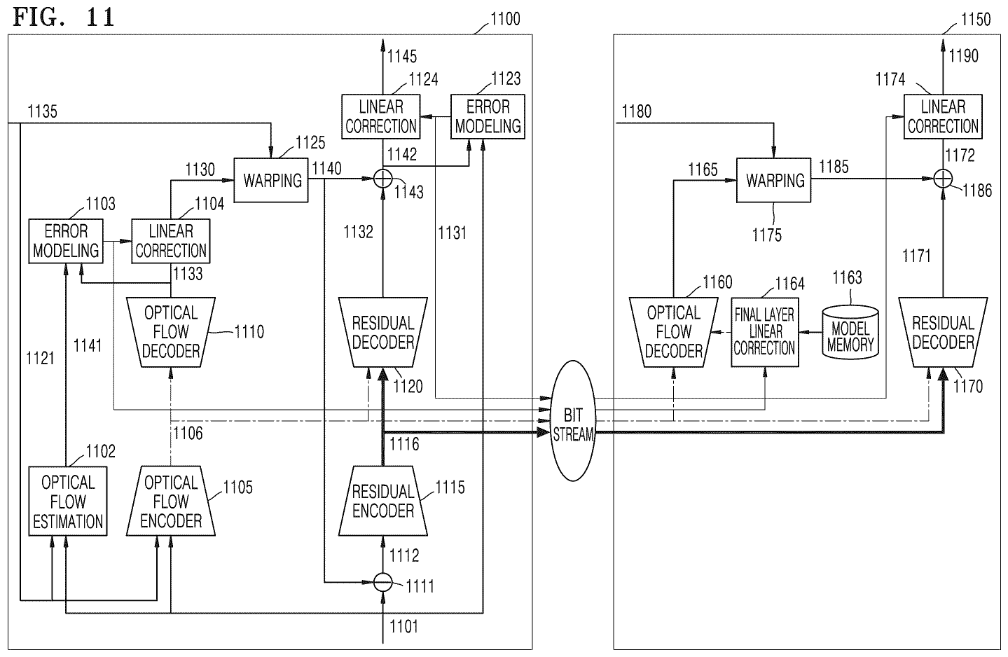

FIG. 11 is a diagram illustrating a process in which linear correction is performed in inter prediction, according to an embodiment of the present disclosure.

Referring to FIG. 11, in inter prediction, as linear correction is additionally performed, the efficiency and image quality of the inter prediction may be improved. In detail, at an encoder 1100, a current original frame 1101 and a previous reconstructed frame 1135 are input to a neural network-based optical flow encoder 1105, to obtain feature data 1106 for an optical flow of the current original frame 1101. The feature data 1106 for the optical flow is input to a neural network-based optical flow decoder 1110, to obtain a decoded optical flow 1133. Optical flow estimation 1102 is performed based on the current original frame 1101 and the previous reconstructed frame 1135, to obtain a frame-based optical flow 1121. Error modeling 1103 is performed based on the decoded optical flow 1033, which is obtained via the neural network, and the frame-based optical flow 1121, to obtain linear correction parameters 1141 for the optical flow. Linear correction 1104 is performed based on the linear correction parameters 1141 and the decoded optical flow 1133, to obtain a reconstructed optical flow 1130. A current predicted frame 1140 for the current original frame 1101 is obtained by performing warping 1125 using the reconstructed optical flow 1130 and the previous reconstructed frame 1135. A residual frame 1112 for the current original frame 1101 is obtained by subtracting 1111 the current predicted frame 1140 from the current original frame 1101. The residual frame 1112 is input to a neural network-based residual encoder 1115, to obtain feature data 1116 for the residual frame 1112. The feature data 1106 for the optical flow and the feature data 1116 for the residual frame 1112 are input to a residual decoder 1120, to obtain a decoded residual frame 1132. The feature data 1106 for the optical flow and the feature data 1116 for the residual frame 1112 are concatenated with each other before being input. A decoded current frame 1142 is obtained by summing 1143 the decoded residual frame 1132 and the current predicted frame 1140. Error modeling 1123 is performed based on the current original frame 1101 and the decoded current frame 1142, to obtain linear correction parameters 1131 for the current frame. Linear correction 1124 is performed based on the decoded current frame 1142 and the linear correction parameters 1131, to obtain a final reconstructed current frame 1145. The feature data 1106 for the optical flow of the current frame, the feature data 1116 for the residual frame 1112 of the current frame, the linear correction parameters 1141 for the optical flow, and the linear correction parameters 1131 for the current frame are transmitted to a decoder 1150 via cost calculation such as SATD or RDO, based on the reconstructed current frame 1145, the linear correction parameters 1141 for the optical flow, and the linear correction parameters 1131 for the current frame.

The decoder 1150 obtains, from a bitstream, the feature data 1106 for the optical flow of the current frame, the feature data 1116 for the residual frame 1112 of the current frame, the linear correction parameters 1141 for the optical flow, and the linear correction parameters 1131 for the current frame. Parameters for a neural network of a neural network-based optical flow decoder 1160 are obtained from a model memory 1163, and final layer linear correction 1164 is performed on final layer parameters of the neural network among the obtained parameters by using the linear correction parameters 1141 for the optical flow, to obtain previous layer parameters and linearly corrected final layer parameters for the optical flow decoder 1160. The feature data 1106 for the optical flow of the current frame is input to the optical flow decoder 1160 to which neural network parameters including the previous layer parameters and the linearly corrected final layer parameters are applied, to obtain a final reconstructed optical flow 1165 to which linear correction is applied. A current predicted frame 1185 is obtained by performing warping 1175 based on the final reconstructed optical flow 1165 and a previous reconstructed frame 1180. In addition, the feature data 1106 for the optical flow of the current frame and the feature data 1116 for the residual frame 1112 of the current frame are input to a neural network-based residual decoder 1170, to obtain a decoded residual frame 1171. The feature data 1106 for the optical flow of the current frame and the feature data 1116 for the residual frame 1112 of the current frame are concatenated with each other before being input. A decoded current frame 1172 is obtained by summing 1186 the decoded residual frame 1171 and the current predicted frame 1185. A final reconstructed current frame 1190 is obtained by performing linear correction 1174 based on the decoded current frame 1172 and the linear correction parameters 1131 for the current frame.

The previous reconstructed frame 1135 at the encoder 1100 and the previous reconstructed frame 1180 at the decoder 1150 are identical to each other, and the optical flow decoder 1110 and the residual decoder 1120 of the encoder 1100 are identical to the optical flow decoder 1160 and the residual decoder 1170 of the decoder 1150, respectively, but they differ in that linear correction is performed on the final layer parameters of the optical flow decoder 1160 of the decoder 1150, and then the linearly corrected final layer parameters are applied.

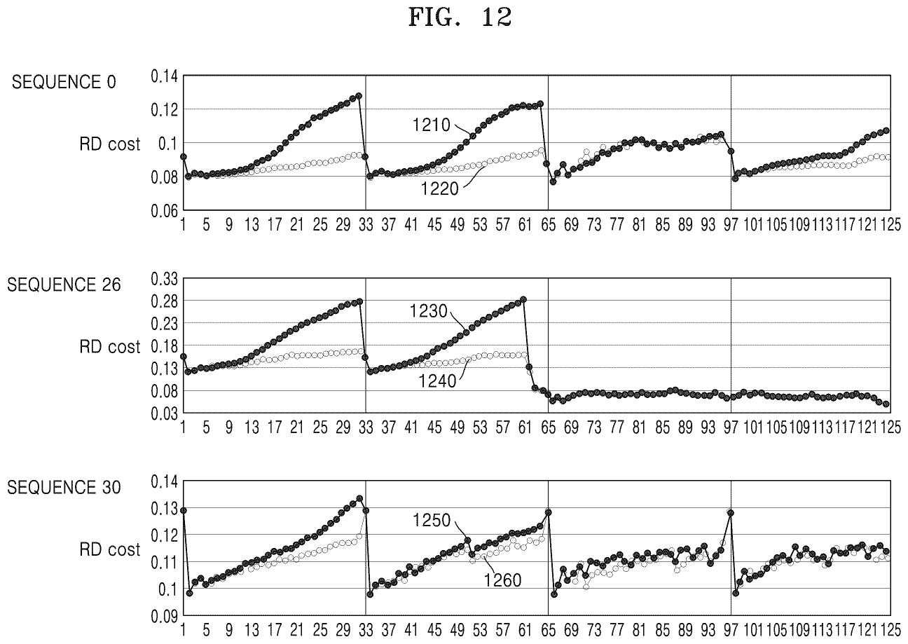

FIG. 12 illustrates an example of a rate-distortion cost for frames of each sequence, and a rate-distortion cost in a case in which linear correction is applied.

Referring to FIG. 12, for sequences 0, 26, and 30, rate-distortion costs 1210, 1230, and 1250 without applied linear correction increase with increasing distance from the intra frame for each intra period, whereas rate-distortion costs 1220, 1240, and 1260 with applied linear correction relatively decrease. That is, as linear correction is applied, the rate-distortion rate decreases even for frames distant from the intra frame, i.e., frames after the intra period, and thus, coding efficiency may be enhanced and image quality may be improved.

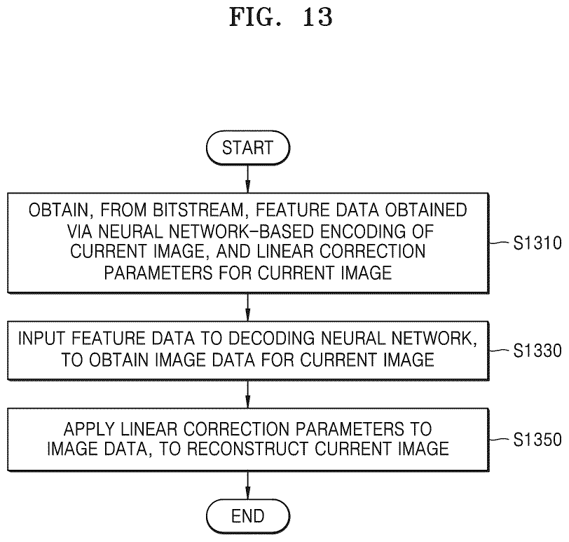

FIG. 13 is a diagram for describing an image decoding method according to an embodiment of the present disclosure.

In operation S1310, an image decoding device 1400 obtains, from a bitstream, feature data obtained via neural network-based encoding of a current image, and linear correction parameters for the current image.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, a decoding neural network may include an image decoder configured to obtain a reconstructed current image, an optical flow decoder configured to obtain an optical flow between a current image and a previous reconstructed image, or a residual decoder configured to obtain a residual image corresponding to a current image.

In operation S1330, the image decoding device 1400 inputs the feature data to the decoding neural network, to obtain image data for the current image.

In operation S1350, the image decoding device 1400 applies the linear correction parameters to the image data, to reconstruct the current image.

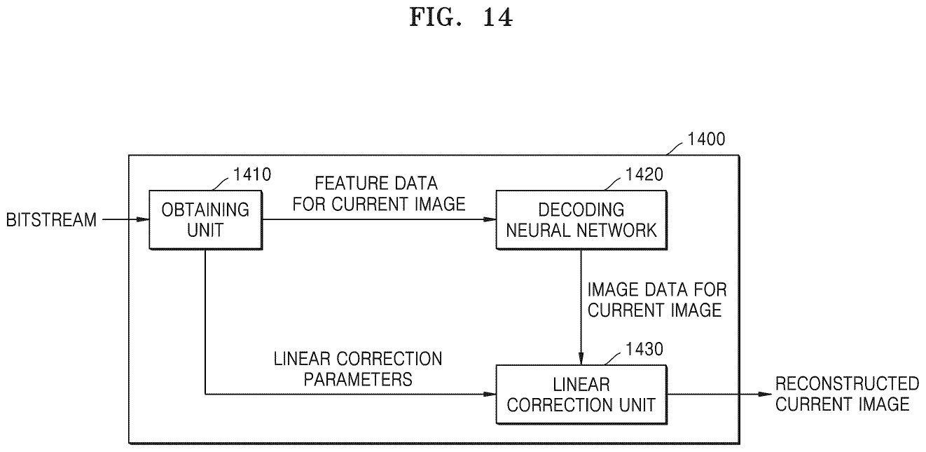

FIG. 14 is a block diagram illustrating a configuration of an image decoding device according to an embodiment of the present disclosure.

Referring to FIG. 14, the image decoding device 1400 according to an embodiment of the present disclosure may include an obtaining unit 1410, a decoding neural network 1420, and a linear correction unit 1430.

The obtaining unit 1410, the decoding neural network 1420, and the linear correction unit 1430 may be implemented as a processor. The obtaining unit 1410, the decoding neural network 1420, and the linear correction unit 1430 may operate according to instructions stored in a memory.

Although FIG. 14 illustrates the obtaining unit 1410, the decoding neural network 1420, and the linear correction unit 1430 as separate components, they may be implemented via a single processor. In this case, the obtaining unit 1410, the decoding neural network 1420, and the linear correction unit 1430 may be implemented as a dedicated processor, or through a combination of software and a general-purpose processor such as an application processor (AP), a central processing unit (CPU), or a graphics processing unit (GPU). In addition, the dedicated processor may include a memory for implementing embodiments of the disclosure or a memory processing unit for using an external memory.

The obtaining unit 1410, the decoding neural network 1420, and the linear correction unit 1430 may also be implemented as a plurality of processors. In this case, the obtaining unit 1410, the decoding neural network 1420, and the linear correction unit 1430 may be implemented as a combination of dedicated processors, or through a combination of software and a plurality of general-purpose processors such as APs, CPUs, or GPUs. In addition, the processor may include an artificial intelligence-dedicated processor. As another example, the artificial intelligence-dedicated processor may be configured as a chip separate from the processor.

The obtaining unit 1410 obtains, from a bitstream, feature data obtained via neural network-based encoding of a current image, and linear correction parameters for the current image.

The decoding neural network 1420 receives the feature data from the obtaining unit 1410, and obtain image data for the current image.

The linear correction unit 1430 receives the image data from the decoding neural network 1420, and receives the linear correction parameters from the obtaining unit 1410. The linear correction unit 1430 applies the linear correction parameters to the image data, to reconstruct the current image.

According to an embodiment, the obtaining unit 1410 may obtain the feature data and the linear correction parameters via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network 1420 may include an image decoder configured to obtain a reconstructed current image, an optical flow decoder configured to obtain an optical flow between a current image and a previous reconstructed image, or a residual decoder configured to obtain a residual image corresponding to a current image.

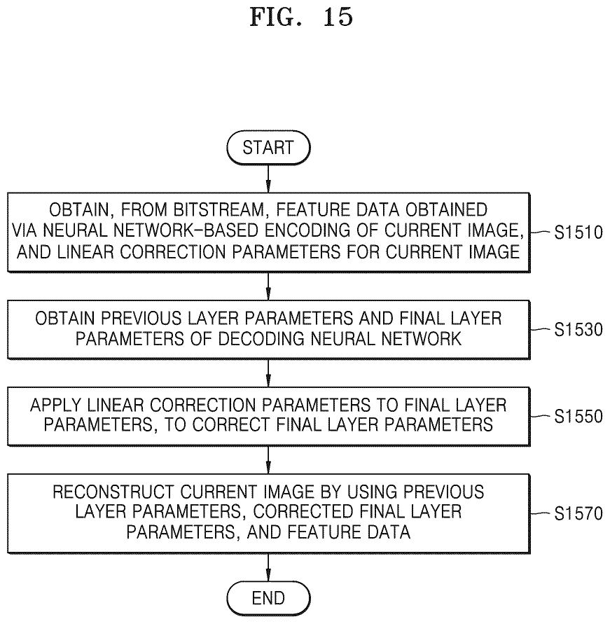

FIG. 15 is a diagram for describing an image decoding method according to an embodiment of the present disclosure.

In operation S1510, an image decoding device 1600 obtains, from a bitstream, feature data obtained via neural network-based encoding of a current image, and linear correction parameters for the current image.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

In operation S1530, the image decoding device 1600 obtains previous layer parameters and final layer parameters of the decoding neural network.

According to an embodiment, the previous layer parameters may be layer parameters of the decoding neural network other than the final layer parameters.

According to an embodiment, a decoding neural network may include an image decoder configured to obtain a reconstructed current image, an optical flow decoder configured to obtain an optical flow between a current image and a previous reconstructed image, or a residual decoder configured to obtain a residual image corresponding to a current image.

In operation S1550, the image decoding device 1600 applies the linear correction parameters to the final layer parameters, to correct the final layer parameters.

In operation S1570, the image decoding device 1600 reconstructs the current image by using the previous layer parameters, the corrected final layer parameters, and the feature data.

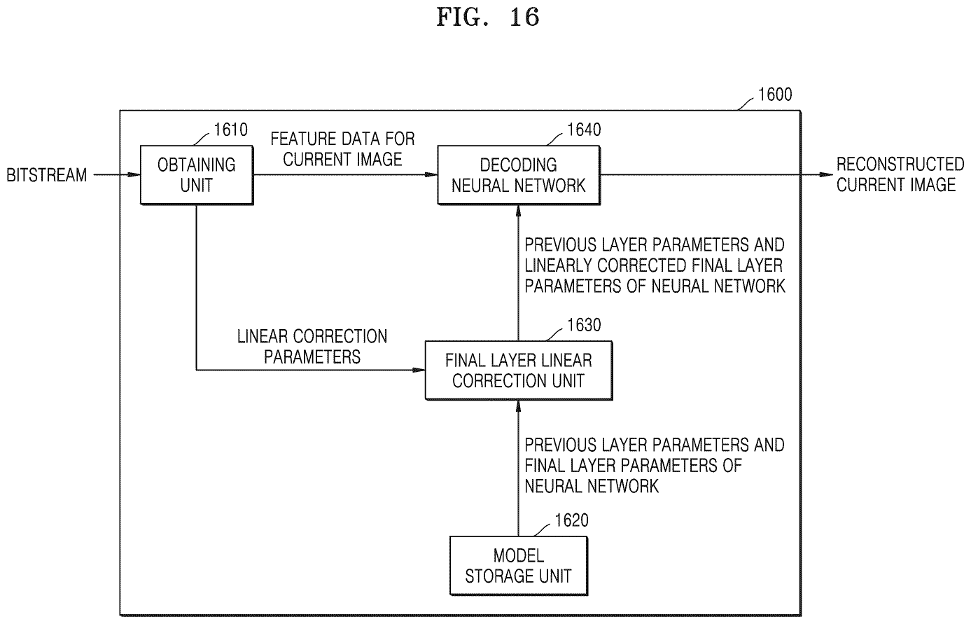

FIG. 16 is a block diagram illustrating a configuration of an image decoding device according to an embodiment of the present disclosure.

Referring to FIG. 16, the image decoding device 1600 according to an embodiment of the present disclosure may include an obtaining unit 1610, a model storage unit 1620, a final layer linear correction unit 1630, and a decoding neural network 1640.

The obtaining unit 1610, the model storage unit 1620, the final layer linear correction unit 1630, and the decoding neural network 1640 may be implemented as a processor. The obtaining unit 1610, the model storage unit 1620, the final layer linear correction unit 1630, and the decoding neural network 1640 may operate according to instructions stored in a memory.

Although FIG. 16 illustrates the obtaining unit 1610, the model storage unit 1620, the final layer linear correction unit 1630, and the decoding neural network 1640 as separate components, they may be implemented via a single processor. In this case, the obtaining unit 1610, the model storage unit 1620, the final layer linear correction unit 1630, and the decoding neural network 1640 may be implemented as a dedicated processor, or through a combination of software and a general-purpose processor such as an AP, a CPU, or a GPU. In addition, the dedicated processor may include a memory for implementing embodiments of the disclosure or a memory processing unit for using an external memory.

The obtaining unit 1610, the model storage unit 1620, the final layer linear correction unit 1630, and the decoding neural network 1640 may also be implemented as a plurality of processors. In this case, the obtaining unit 1610, the model storage unit 1620, the final layer linear correction unit 1630, and the decoding neural network 1640 may be implemented as a combination of dedicated processors, or through a combination of software and a plurality of general-purpose processors such as APs, CPUs, or GPUs. In addition, the processor may include an artificial intelligence-dedicated processor. As another example, the artificial intelligence-dedicated processor may be configured as a chip separate from the processor.

The obtaining unit 1610 obtains, from a bitstream, feature data obtained via neural network-based encoding of a current image, and linear correction parameters for the current image.

The model storage unit 1620 obtains previous layer parameters and final layer parameters of the decoding neural network 1640.

The final layer linear correction unit 1630 receives the previous layer parameters and the final layer parameters from the model storage unit 1620, and receives the linear correction parameters from the obtaining unit 1610. The final layer linear correction unit 1630 applies the linear correction parameters to the final layer parameters, to correct the final layer parameters.

The decoding neural network 1640 receives the previous layer parameters and the corrected final layer parameters from the final layer linear correction unit 1630, and receives the feature data from the obtaining unit 1610. The decoding neural network 1640 reconstructs the current image by using the previous layer parameters, the corrected final layer parameters, and the feature data.

According to an embodiment, the previous layer parameters may be layer parameters of the decoding neural network 1640 other than the final layer parameters.

According to an embodiment, the obtaining unit 1610 may obtain the feature data and the linear correction parameters via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network 1640 may include an image decoder configured to obtain a reconstructed current image, an optical flow decoder configured to obtain an optical flow between a current image and a previous reconstructed image, or a residual decoder configured to obtain a residual image corresponding to a current image.

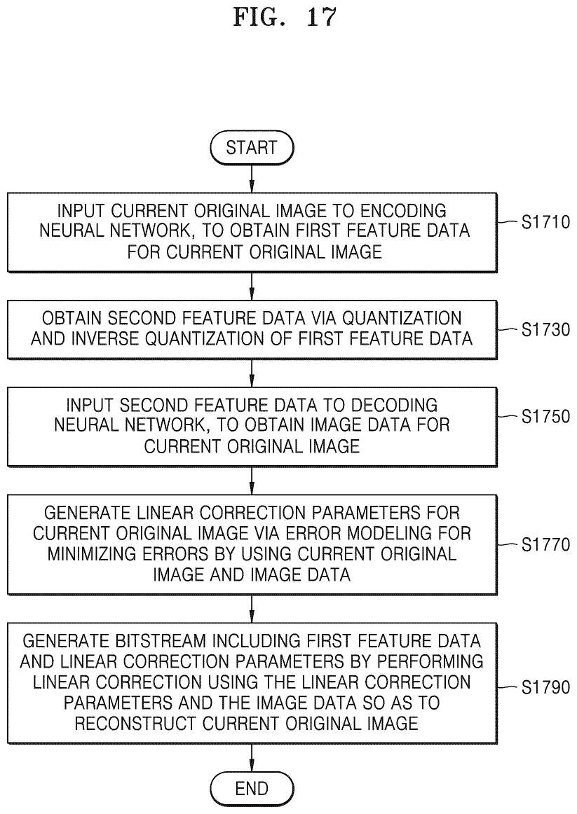

FIG. 17 is a diagram for describing an image encoding method according to an embodiment of the present disclosure.

In operation S1710, an image encoding device 1800 inputs a current original image to an encoding neural network, to obtain first feature data for the current original image.

According to an embodiment, the first feature data may include feature data obtained by applying the current original image to an image encoder, feature data obtained by applying the current original image and a previous reconstructed image to an optical flow encoder, or feature data obtained by applying a residual image corresponding to the current original image to a residual encoder.

According to an embodiment, the encoding neural network may include an image encoder configured to obtain feature data for a current original image, an optical flow encoder configured to obtain feature data for an optical flow between a current original image and a previous reconstructed image, or a residual decoder configured to obtain feature data for a residual image corresponding to a current original image.

In operation S1730, the image encoding device 1800 obtains second feature data via quantization and inverse quantization of the first feature data.

In operation S1750, the image encoding device 1800 inputs the second feature data to a decoding neural network, to obtain image data for the current original image.

According to an embodiment, the decoding neural network may include an image decoder configured to obtain a reconstructed current original image, an optical flow decoder configured to obtain an optical flow between a current original image and a previous reconstructed image, or a residual decoder configured to obtain a residual image corresponding to a current original image.

In operation S1770, the image encoding device 1800 generates linear correction parameters for the current original image via error modeling for minimizing errors by using the current original image and the image data.

According to an embodiment, the linear correction parameters may include a multiplicative parameter and an additive parameter.

In operation S1790, the image encoding device 1800 generates a bitstream including the first feature data and the linear correction parameters by performing linear correction using the linear correction parameters and the image data so as to reconstruct the current original image.

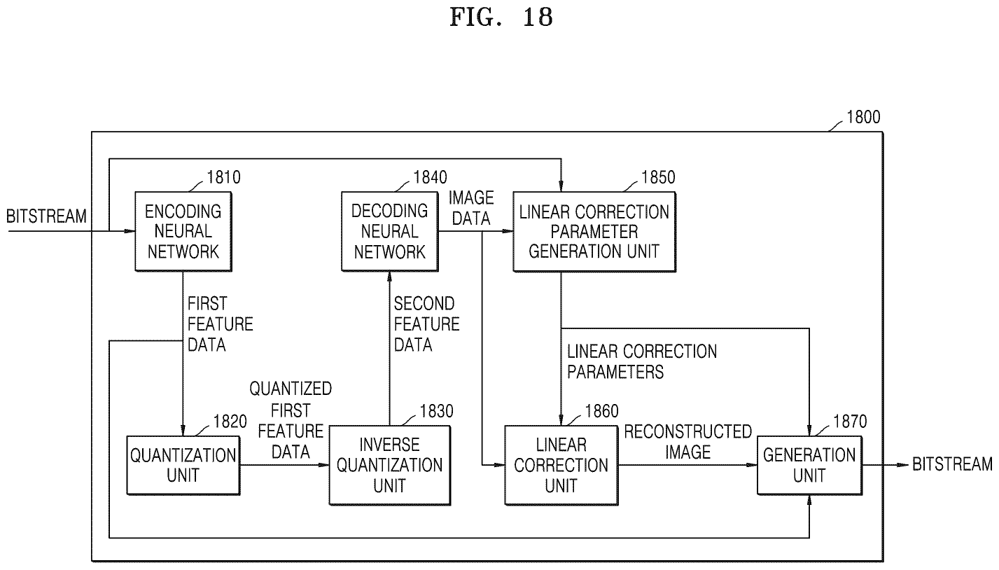

FIG. 18 is a block diagram illustrating a configuration of an image encoding device according to an embodiment of the present disclosure.

Referring to FIG. 18, the image encoding device 1800 according to an embodiment of the present disclosure may include an encoding neural network 1810, a quantization unit 1820, an inverse quantization unit 1830, a decoding neural network 1840, a linear correction parameter generation unit 1850, a linear correction unit 1860, and a generation unit 1870.

The encoding neural network 1810, the quantization unit 1820, the inverse quantization unit 1830, the decoding neural network 1840, the linear correction parameter generation unit 1850, the linear correction unit 1860, and the generation unit 1870 may be implemented as a processor. The encoding neural network 1810, the quantization unit 1820, the inverse quantization unit 1830, the decoding neural network 1840, the linear correction parameter generation unit 1850, the linear correction unit 1860, and the generation unit 1870 may operate according to instructions stored in a memory.

Although FIG. 18 illustrates the encoding neural network 1810, the quantization unit 1820, the inverse quantization unit 1830, the decoding neural network 1840, the linear correction parameter generation unit 1850, the linear correction unit 1860, and the generation unit 1870 as separate components, they may be implemented as a single processor. In this case, the encoding neural network 1810, the quantization unit 1820, the inverse quantization unit 1830, the decoding neural network 1840, the linear correction parameter generation unit 1850, the linear correction unit 1860, and the generation unit 1870 may be implemented as a dedicated processor, or through a combination of software and a general-purpose processor such as an AP, a CPU, or a GPU. In addition, the dedicated processor may include a memory for implementing embodiments of the disclosure or a memory processing unit for using an external memory.

The encoding neural network 1810, the quantization unit 1820, the inverse quantization unit 1830, the decoding neural network 1840, the linear correction parameter generation unit 1850, the linear correction unit 1860, and the generation unit 1870 may also be implemented as a plurality of processors. In this case, the encoding neural network 1810, the quantization unit 1820, the inverse quantization unit 1830, the decoding neural network 1840, the linear correction parameter generation unit 1850, the linear correction unit 1860, and the generation unit 1870 may be implemented as a combination of dedicated processors, or through a combination of software and a plurality of general-purpose processors such as APs, CPUs, or GPUs. In addition, the processor may include an artificial intelligence-dedicated processor. As another example, the artificial intelligence-dedicated processor may be configured as a chip separate from the processor.

The encoding neural network 1810 receives a current original image as input, and obtains first feature data for the current original image.

The quantization unit 1820 receives the first feature data from the encoding neural network 1810, and performs quantization on the first feature data to obtain quantized first feature data.

According to an embodiment, the first feature data may include feature data obtained by applying the current original image to an image encoder, feature data obtained by applying the current original image and a previous reconstructed image to an optical flow encoder, or feature data obtained by applying a residual image corresponding to the current original image to a residual encoder.

According to an embodiment, the encoding neural network 1810 may include an image encoder configured to obtain feature data for a current original image, an optical flow encoder configured to obtain feature data for an optical flow between a current original image and a previous reconstructed image, or a residual decoder configured to obtain feature data for a residual image corresponding to a current original image.

According to an embodiment, the quantization unit 1820 performs entropy encoding on the quantized first feature data.

The inverse quantization unit 1830 receives the quantized first feature data from the quantization unit 1820, and performs inverse quantization to obtain second feature data.

According to an embodiment, the inverse quantization unit 1830 performs entropy decoding to obtain the quantized first feature data.

The decoding neural network 1840 receives the second feature data from the inverse quantization unit 1830, and the second feature data is input to the decoding neural network to obtain image data for the current original image.

According to an embodiment, the decoding neural network 1840 may include an image decoder configured to obtain a reconstructed current original image, an optical flow decoder configured to obtain an optical flow between a current original image and a previous reconstructed image, or a residual decoder configured to obtain a residual image corresponding to a current original image.

The linear correction parameter generation unit 1850 generates linear correction parameters for the current original image via error modeling for minimizing errors by using the current original image and the image data received from the decoding neural network 1840.

According to an embodiment, the linear correction parameters may include a multiplicative parameter and an additive parameter.

The linear correction unit 1860 performs linear correction by using the linear correction parameters received from the linear correction parameter generation unit 1850 and the image data received from the decoding neural network 1840, to reconstruct the current original image.

The generation unit 1870 generates a bitstream including the first feature data received from the encoding neural network 1810 and the linear correction parameters received from the linear correction parameter generation unit 1850, via cost calculation such as SATD or RDO, based on the reconstructed current original image and the linear correction parameters.

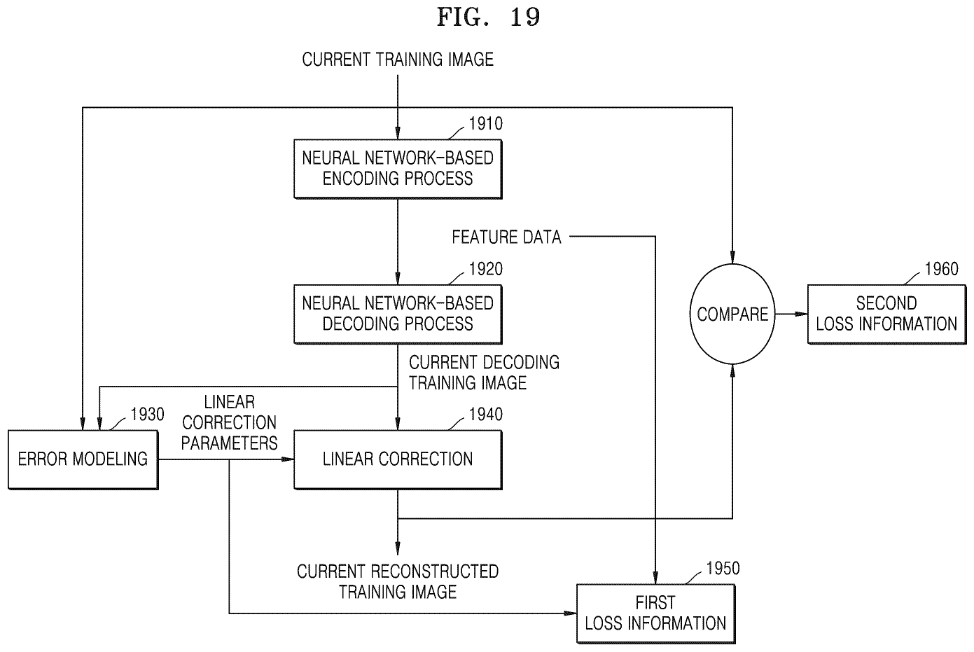

The linear correction parameters may be obtained via calculation using pre-trained neural networks, and may be trained together with the neural networks by simultaneously performing error modeling and linear correction processes during training. A method of training neural networks by adding error modeling and linear correction processes will be described with reference to FIG. 19.

FIG. 19 is a diagram for describing a method of training neural networks, according to an embodiment of the present disclosure.

Referring to FIG. 19, a current training image may correspond to a current image, a current reconstructed training image may correspond to a current reconstructed image, and a current decoded training image may correspond to a decoded image for the current image.

In a training process according to an embodiment, neural networks may be trained such that the current reconstructed training image is maximally similar to the current training image, and the bitrate of a bitstream including feature data for the current training image and linear correction parameters is minimized. To this end, as illustrated in FIG. 19, first loss information 1950 and second loss information 1960 may be used for training the neural networks.

Describing the process of training the neural networks in detail, first, feature data for the current training image may be obtained by applying a neural network-based encoding process 1910 to the current training image.

The neural network-based encoding process 1910 may be a process of encoding the current training image based on the image encoder 12, the optical flow encoder 42, and/or the residual encoder 52.

The feature data may include at least one of feature data obtained by processing the current training image by using the image encoder 12, feature data obtained by processing the current training image and a previous reconstructed training image by using the optical flow encoder 42, or feature data obtained by processing a residual training image corresponding to a difference between the current training image and a current predicted training image by using the residual encoder 52. Here, the current predicted training image may be obtained as the previous reconstructed training image is transformed according to the optical flow g.

The feature data obtained via the neural network-based encoding process 1910 may be processed according to a neural network-based decoding process 1920, to obtain the current reconstructed training image. The feature data may undergo quantization, entropy encoding, entropy decoding, and inverse quantization processes, and then be input to the neural network-based decoding process 1920.

The neural network-based decoding process may be a process of reconstructing the current image 100 based on the image decoder 14, the optical flow decoder 44, and/or the residual decoder 54.

For training the neural network used in the neural network-based encoding process and the neural network used in the neural network-based decoding process, at least one of the first loss information 1950 or the second loss information 1960 may be obtained.

The first loss information 1950 may be calculated based on the bitrate of a bitstream generated as a result of encoding the feature data for the current training image and the linear correction parameters.

The first loss information 1950 is associated with the efficiency of encoding the feature data for the current training image and the linear correction parameters, and thus may also be referred to as compression loss information.

The second loss information 1960 may correspond to a difference between the current training image and the current reconstructed training image. In an embodiment, the difference between the current training image and the current reconstructed training image may include at least one of an L1-norm value, an L2-norm value, a structural similarity (SSIM) value, a peak signal-to-noise ratio-human vision system (PSNR-HVS) value, a multiscale SSIM (MS-SSIM) value, a variance inflation factor (VIF) value, or a video multimethod assessment fusion (VMAF) value between the current training image and the current reconstructed training image.

The second loss information 1960 is associated with the quality of the current reconstructed training image, and thus may also be referred to as quality loss information.

The neural network used in the neural network-based encoding process and the neural network used in the neural network-based decoding process may be trained such that final loss information derived from at least one of the first loss information 1950 or the second loss information 1960 is reduced or minimized.

In an embodiment, the neural network used in the neural network-based encoding process and the neural network used in the neural network-based decoding process may be trained by adjusting preset parameter values such that the final loss information is reduced or minimized.

In an embodiment, the final loss information may be calculated according to Equation 9 below.

Final loss information=a*(First loss information)+b*(Second loss information) [Equation 9]

In Equation 9, a and b denote weights applied to the first loss information 1950 and the second loss information 1960, respectively.

According to Equation 9, it may be confirmed that the neural network used in the neural network-based encoding process and the neural network used in the neural network-based decoding process are trained such that the current reconstructed training image is maximally similar to the current training image, and the size of the bitstream is minimized.

The training process described above with reference to FIG. 19 may be performed by a training device. The training device may be, for example, the image encoding device 1800 or a separate server. Parameters obtained as a result of the training may be stored in the image encoding device 1800 and the image decoding device 1400 or 1600.

According to an embodiment, an image decoding method may include: obtaining, from a bitstream, feature data obtained via neural network-based encoding of a current image, and linear correction parameters for the current image; obtaining image data for the current image by inputting the feature data to a decoding neural network; and reconstructing the current image by applying the linear correction parameters to the image data.

According to an embodiment of the present disclosure, the image decoding method may perform linear correction using linear correction parameters, to reduce coding errors and error propagation that occur in decoded images, frames, or optical flows, and thus improve image quality. In intra prediction, a decoded frame may be corrected, and in inter prediction, a decoded frame, a decoded residual frame, or a decoded optical flow may be corrected.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network may include an image decoder configured to obtain a reconstructed image for the current image, an optical flow decoder configured to obtain an optical flow between the current image and the previous reconstructed image, or a residual decoder configured to obtain the residual image corresponding to the current image.

According to an embodiment, an image decoding device may include: a memory storing one or more instructions; and at least one processor configured to operate according to the one or more instructions, wherein the at least one processor is further configured to obtain, from a bitstream, feature data obtained via neural network-based encoding of a current image, and linear correction parameters for the current image, obtain image data for the current image by inputting the feature data to a decoding neural network, and reconstruct the current image by applying the linear correction parameters to the image data.

According to an embodiment of the present disclosure, the image decoding device may perform linear correction using linear correction parameters, to reduce coding errors and error propagation that occur in decoded images, frames, or optical flows, and thus improve image quality.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network may include an image decoder configured to obtain a reconstructed image for the current image, an optical flow decoder configured to obtain an optical flow between the current image and the previous reconstructed image, or a residual decoder configured to obtain the residual image corresponding to the current image.

According to an embodiment, an image decoding method may include: obtaining, from a bitstream, feature data obtained via neural network-based encoding of a current image, and linear correction parameters for the current image; obtaining previous layer parameters and final layer parameters for a decoding neural network; correcting the final layer parameters by applying the linear correction parameters to the final layer parameters; and reconstructing the current image by using the previous layer parameters, the corrected final layer parameters, and the feature data.

According to an embodiment of the present disclosure, the image decoding method uses linear correction parameters to correct and utilize final layer parameters of a decoding neural network used in a decoding process, thereby reducing coding errors and error propagation that occur in decoded images, frames, or optical flows, reducing the number of multiplication and addition calculations to reduce the amount of calculation, and improving image quality.

According to an embodiment, the previous layer parameters may be layer parameters of the decoding neural network other than the final layer parameters.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network may include an image decoder configured to obtain a reconstructed image for the current image, an optical flow decoder configured to obtain an optical flow between the current image and the previous reconstructed image, or a residual decoder configured to obtain the residual image corresponding to the current image.

According to an embodiment, an image decoding device may include: a memory storing one or more instructions; and at least one processor configured to operate according to the one or more instructions, wherein the at least one processor is further configured to obtain, from a bitstream, feature data obtained via neural network-based encoding of a current image, and linear correction parameters for the current image, obtain previous layer parameters and final layer parameters for a decoding neural network, correct the final layer parameters by applying the linear correction parameters to the final layer parameters, and reconstruct the current image by using the previous layer parameters, the corrected final layer parameters, and the feature data.

According to an embodiment of the present disclosure, the image decoding device uses linear correction parameters to correct and utilize final layer parameters of a decoding neural network used in a decoding process, thereby reducing coding errors and error propagation that occur in decoded images, frames, or optical flows, reducing the number of multiplication and addition calculations to reduce the amount of calculation, and improving image quality.

According to an embodiment, the previous layer parameters may be layer parameters of the decoding neural network other than the final layer parameters.

According to an embodiment, the feature data and the linear correction parameters may be obtained via entropy decoding and inverse quantization.

According to an embodiment, the linear correction parameters may include a multiplicative parameter and an additive parameter.

According to an embodiment, the feature data may include feature data obtained by applying the current image to an image encoder, feature data obtained by applying the current image and a previous reconstructed image to an optical flow encoder, or feature data obtained by applying a residual image corresponding to the current image to a residual encoder.

According to an embodiment, the decoding neural network may include an image decoder configured to obtain a reconstructed image for the current image, an optical flow decoder configured to obtain an optical flow between the current image and the previous reconstructed image, or a residual decoder configured to obtain the residual image corresponding to the current image.

According to an embodiment, an image encoding method may include: obtaining first feature data for a current original image by inputting the current original image to an encoding neural network; obtaining second feature data via quantization and inverse quantization of the first feature data; obtaining image data for the current original image by inputting the second feature data to a decoding neural network; generating linear correction parameters for the current original image via error modeling for minimizing errors by using the current original image and the image data; and generating a bitstream including the first feature data and the linear correction parameters, by performing linear correction using the linear correction parameters and the image data to reconstruct the current original image.

According to an embodiment of the present disclosure, the image encoding method may generate linear correction parameters via error modeling using an original image and a reconstructed image, transmit the generated parameters to a decoding side, and perform linear correction for using a subsequent frame as a reference, thereby reducing coding errors and error propagation and thus improving image quality.

According to an embodiment, the linear correction parameters may include a multiplicative parameter and an additive parameter.

According to an embodiment, the first feature data may include feature data obtained by applying the current original image to an image encoder, feature data obtained by applying the current original image and a previous reconstructed image to an optical flow encoder, or feature data obtained by applying a residual image corresponding to the current original image to a residual encoder.

According to an embodiment, the decoding neural network may include an image decoder configured to obtain a reconstructed image for the current original image, an optical flow decoder configured to obtain an optical flow between the current original image and the previous reconstructed image, or a residual decoder configured to obtain the residual image corresponding to the current original image.

According to an embodiment, an image encoding device may include: a memory storing one or more instructions; and at least one processor configured to operate according to the one or more instructions, wherein the at least one processor is further configured to obtain first feature data for a current original image by inputting the current original image to an encoding neural network, obtain second feature data via quantization and inverse quantization of the first feature data, obtain image data for the current original image by inputting the second feature data to a decoding neural network, generate linear correction parameters for the current original image via error modeling for minimizing errors by using the current original image and the image data, and generate a bitstream including the first feature data and the linear correction parameters, by performing linear correction using the linear correction parameters and the image data to reconstruct the current original image.

According to an embodiment of the present disclosure, the image encoding device may generate linear correction parameters via error modeling using an original image and a reconstructed image, transmit the generated parameters to a decoding side, and perform linear correction for using a subsequent frame as a reference, thereby reducing coding errors and error propagation and thus improving image quality.

According to an embodiment, the linear correction parameters may include a multiplicative parameter and an additive parameter.

According to an embodiment, the first feature data may include feature data obtained by applying the current original image to an image encoder, feature data obtained by applying the current original image and a previous reconstructed image to an optical flow encoder, or feature data obtained by applying a residual image corresponding to the current original image to a residual encoder.

According to an embodiment, the decoding neural network may include an image decoder configured to obtain a reconstructed image for the current original image, an optical flow decoder configured to obtain an optical flow between the current original image and the previous reconstructed image, or a residual decoder configured to obtain the residual image corresponding to the current original image.

A machine-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

According to an embodiment, methods according to various embodiments disclosed herein may be included in a computer program product and then provided. The computer program product may be traded as commodities between sellers and buyers. The computer program product may be distributed in the form of a machine-readable storage medium (e.g., a compact disc read-only memory (CD-ROM)), or may be distributed online (e.g., downloaded or uploaded) through an application store or directly between two user devices (e.g., smart phones). In a case of online distribution, at least a portion of the computer program product (e.g., a downloadable app) may be temporarily stored in a machine-readable storage medium such as a manufacturer's server, an application store's server, or a memory of a relay server.

What is claimed is:

1. An image decoding method comprising:
obtaining, from a bitstream, feature data obtained via neural network-based encoding of a current image, and linear correction parameters for the current image;
obtaining image data for the current image by inputting the feature data to a decoding neural network; and
reconstructing the current image by applying the linear correction parameters to the image data.

2. The image decoding method of claim 1, wherein the obtaining the feature data and the linear correction parameters comprises applying entropy decoding and inverse quantization to the bitstream.

3. The image decoding method of claim 1, wherein the linear correction parameters comprise a multiplicative parameter and an additive parameter.

4. The image decoding method of claim 1, wherein the feature data comprises:
feature data obtained by applying the current image to an image encoder;
feature data obtained by applying the current image and a previous reconstructed image to an optical flow encoder; or
feature data obtained by applying, to a residual encoder, a residual image corresponding to the current image.

5. The image decoding method of claim 4, wherein the decoding neural network comprises:
an image decoder configured to obtain a reconstructed image for the current image;
an optical flow decoder configured to obtain an optical flow between the current image and the previous reconstructed image; or
a residual decoder configured to obtain the residual image corresponding to the current image.

6. An image decoding method comprising:
obtaining, from a bitstream, feature data obtained via neural network-based encoding of a current image, and linear correction parameters for the current image;
obtaining previous layer parameters and final layer parameters for a decoding neural network;
correcting the final layer parameters by applying the linear correction parameters to the final layer parameters; and
reconstructing the current image by using the previous layer parameters, the corrected final layer parameters, and the feature data.

7. The image decoding method of claim 6, wherein the previous layer parameters comprise layer parameters of the decoding neural network other than the final layer parameters.

8. The image decoding method of claim 6, wherein the obtaining the feature data and the linear correction parameters comprises applying entropy decoding and inverse quantization to the bitstream.

9. The image decoding method of claim 6, wherein the linear correction parameters comprise a multiplicative parameter and an additive parameter.

10. The image decoding method of claim 6, wherein the feature data comprises:
feature data obtained by applying the current image to an image encoder;
feature data obtained by applying the current image and a previous reconstructed image to an optical flow encoder; or
feature data obtained by applying, to a residual encoder, a residual image corresponding to the current image.

11. The image decoding method of claim 10, wherein the decoding neural network comprises an image decoder configured to obtain a reconstructed image for the current image, an optical flow decoder configured to obtain an optical flow between the current image and the previous reconstructed image, or a residual decoder configured to obtain the residual image corresponding to the current image.

12. An image encoding method comprising:
obtaining first feature data for a current original image by inputting the current original image to an encoding neural network;
obtaining second feature data via quantization and inverse quantization of the first feature data;
obtaining image data for the current original image by inputting the second feature data to a decoding neural network;
generating linear correction parameters for the current original image via error modeling for minimizing errors by using the current original image and the image data; and
generating a bitstream comprising the first feature data and the linear correction parameters, by performing linear correction using the linear correction parameters and the image data to reconstruct the current original image.

13. The image encoding method of claim 12, wherein the linear correction parameters comprise a multiplicative parameter and an additive parameter.

14. The image encoding method of claim 12, wherein the first feature data comprises:
feature data obtained by applying the current original image to an image encoder;
feature data obtained by applying the current original image and a previous reconstructed image to an optical flow encoder; or
feature data obtained by applying, to a residual encoder, a residual image corresponding to the current original image.

15. The image encoding method of claim 14, wherein the decoding neural network comprises:
an image decoder configured to obtain a reconstructed image for the current original image;
an optical flow decoder configured to obtain an optical flow between the current original image and the previous reconstructed image; or
a residual decoder configured to obtain the residual image corresponding to the current original image.
